(19) United States
(12) Patent Application Publication
(10) Pub. No.: US 2007/0208587 A1
(43) Pub. Date: Sep. 6, 2007

(54) SYSTEMS, SOFTWARE, AND METHODS FOR COMMUNICATION-BASED BUSINESS PROCESS MESSAGING

(76) Inventor: Arun Sitaraman, Sunnyvale, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/625,757

(22) Filed: Jan. 22, 2007

Related U.S. Application Data
(63) Continuation-in-part of application No. 11/275,084, filed on Dec. 8, 2005.

(51) Int. Cl. G06Q 10/00; G06Q 30/00

(52) U.S. Cl. 705/1

(57) ABSTRACT

A computerized system is described. The systems and methods of example embodiments include one or more shells for maintaining information, and one or more requests and responses related to the information to be maintained. A workflow paradigm may govern the acquisition and/or management of information through the requests and responses.

### RELATED APPLICATIONS

This application is a continuation-in-part of U.S. application Ser. No. 11/275,084, entitled “SYSTEMS, SOFTWARE, AND METHODS FOR COMMUNICATION-BASED BUSINESS PROCESS MESSAGING” which application claims priority to U.S. application Ser. No. 11/126,058, entitled “SYSTEMS, SOFTWARE, AND METHODS FOR COMMUNICATION-BASED BUSINESS PROCESS MESSAGING,” filed on May 9, 2005, the entire specification of which is hereby incorporated by reference, which in turn claims priority to U.S. Provisional Application Ser. No. 60/591,155 entitled “SMARTSCREEN” filed on Jul. 26, 2004, and to U.S. Provisional Application Ser. No. 60/568,796, entitled “EZBIZ,” filed on May 7, 2004.

### FIELD

The present inventive subject matter relates to the field of computer systems and more particularly to systems, software, and methods for communication-based business process messaging.

### BACKGROUND

Affecting effective business process communication is a major challenge across the industry, despite the fact that communication is often the driver of business processes in many businesses. Process users initiate unstructured requests in an ad-hoc manner via a variety of communication media, which results in more than required exchanges and actions (between process users, systems and information resources), redirections (to other process users, systems and information resources), redundancy, inaccurate and partial exchanges, irrelevant actions, and increased latency (in the time to fulfill the request). Users who provide services often have to tediously identify and use a variety of systems and information sources (often disparate), to fulfill these requests, respond and communicate in an unstructured and ad-hoc manner during the course of request fulfillment.

Besides adversely impacting time to market goals, unstructured and ad-hoc requests and responses adversely impact businesses by contributing to productivity loss, process failures, opportunity and operating costs, undesirable customer satisfaction, and human stress. Additionally unstructured and ad-hoc requests and responses do not allow for tracking and monitoring business processes; as a result very little can be discerned, reported, audited, and understood with respect to compliance, and overall efficiency and performance—there is none or insufficient scope to derive intelligence from the business process, and none or insufficient visibility into it. Furthermore, unstructured and ad-hoc requests and responses may fail to provide for secure messaging and communications.

### BRIEF DESCRIPTION OF THE DRAWINGS

FIG. 1 is a diagram of a business process hierarchy.

FIG. 2 is a diagram of an example business message for use within the business process hierarchy shown in FIG. 1.

FIG. 3A is a diagram of a composite message data structure used to implement the business message shown in FIG. 2 according to an example embodiment.

FIG. 3B is a table listing examples for each of the components of the composite message shown in FIG. 3A according to an example embodiment.

FIG. 4 is an example of a communication exchange using a business message.

FIG. 5 is a block diagram illustrating types of business information containers according to an example embodiment.

FIG. 6 is a block diagram of an information structure within the composite message shown in FIG. 3A according to an example embodiment.

FIG. 7 is a block diagram of a system for automating and integrating a business process according to an example embodiment.

FIG. 8 is a more detailed block diagram of the system shown in FIG. 7 according to an example embodiment.

FIG. 9 is a more detailed block diagram of the business information container designer of the IDE shown in FIG. 8 according to an example embodiment.

FIG. 10 is a more detailed block diagram of the business communication orchestrator of the IDE shown in FIG. 8 according to an example embodiment.

FIG. 11 is a more detailed block diagram of the workflow designer and the collaboration orchestrator of the IDE shown in FIG. 8 according to an example embodiment.

FIG. 12A is a more detailed block diagram of the communication and information server shown in FIG. 8 according to an example embodiment.

FIG. 12B illustrates an example user interface for a dashboard.

FIG. 12C is a block diagram of an example embodiment of a communication-based business process messaging system comprising a synopsis view of the business process communications activities.

FIG. 13a, 13b and 13C are diagrams of example types of business messages.

FIG. 14 is a block diagram of example message queues for business messages in a communication-based business processing messaging system.

FIG. 15 is a diagram of a method according to an alternate embodiment.

FIGS. 16, 17, 18, 19A and 19B are diagrams illustrating a business automation example according to an embodiment.

FIGS. 20, 21, 22 and 23 are diagrams illustrating a business process outsourcing example according to an embodiment.

FIGS. 24, 25, 26 and 27 are diagrams illustrating a business reporting example according to an embodiment.

FIG. 28 is a diagram illustrating an implementation of a Communication and Information Exchange (CIX) according to various embodiments.

FIG. 29 is a diagram illustrating an example process for collecting business information according to various embodiments.

FIG. 30 is a flow diagram illustrating a method for working with business information according to various embodiments.

FIG. 31 is a diagram illustrating an example request form and corresponding response data according to an embodiment.

FIG. 32 is a diagram illustrating a communication system according to various embodiments.

FIG. 33 is a diagram of an example hardware and operating environment for a computerized system according to an example embodiment.

### DETAILED DESCRIPTION

The following is a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

The following detailed description is divided into four sections. The first section presents a system overview of the inventive subject matter. The second section provides methods of using example embodiments of the inventive subject matter. The third section describes example implementations. The fourth section describes the hardware and the operating environment in conjunction with which embodiments of the invention can be practiced.

### System Overview

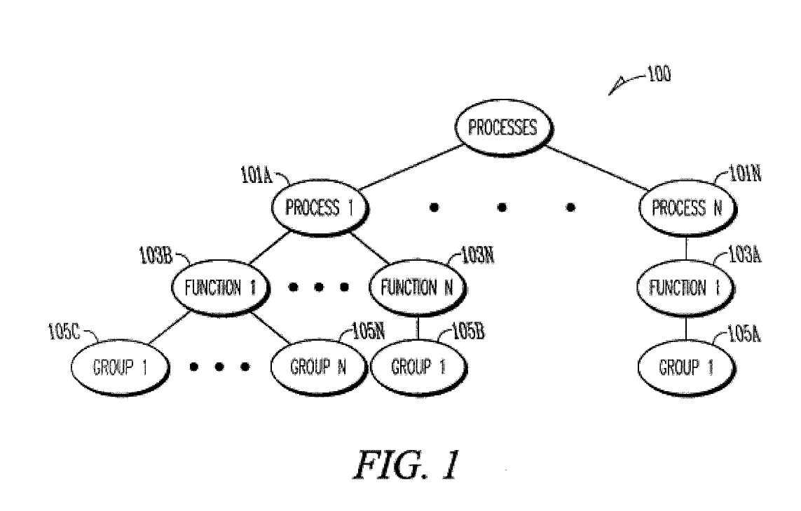

FIGS. 1-12 provide a system overview of example embodiments of the invention. Systems, methods, and software for communication-based business process messaging are described. “Business process messaging” is the creation, storage, exchange, and management over a network of communications related to one or more business processes. In general, communications related to a business process include, but are not limited to text, images, voice, fax, e-mail, paging, and the like. Embodiments of the invention provide a novel form of communication called as a business message. A “business message” is an electronic communication mechanism based on a request/response paradigm within a business process. Various types of business messages are described later in the Detailed Description. A business message is implemented using a data structure called a “composite message.” A “composite message” is a data structure providing a common interface between different modes of communication within a business process.

FIG. 1 is a diagram of a business process hierarchy. The business process hierarchy 100 comprises one or more business processes 101a-101n. The term “business process” refers to a collection of related activities (e.g., requests, responses, alerts and so on), information resources (e.g., documents, messages, systems, applications and so on), and users/people (including inter/intra business process functional groups/subgroups) that produce a specific outcome. The term business process as used throughout this Detailed Description may be either an inter or intra business process. Each one of the business processes 101a-101n comprises the entities that make up a business process, people and their accessibility, access controlled information resources needed by people to take an action, workflow and process control and so on.

As shown in FIG. 1, a business process 101a-101n may comprise one or more functions 103a, 103b-103n. Each one of the functions 103a, 103b-103n, involves one or more business process groups 105a, 105b, 105c-105n. The business process groups 105a, 105b, 105c-105n include one or more people, systems, information resources, and the relationships between all of them. The groups 105a, 105b, 105c-105n may include both inter process groups and/or intra process groups. The groups 105a, 105b, 105c-105n may also include subgroups in the business process hierarchy which are not shown in FIG. 1. In the business process hierarchy 100, the business processes 101a-101n and the functions 103a, 103b-103n, may have an associated workflow to control the flow of communications (e.g., sequencing and state changes described later in the Detailed Description).

“Communication” refers to the exchange of thoughts, messages or information. Communication is driven in the business process hierarchy 100 shown in FIG. 1 using novel business messages. As defined above, a business message is an electronic communication mechanism based on a request/response paradigm within a business process. Different types of business messages are described later in the Methods section. In addition, some examples of the use of business messages in a business process hierarchy 100 are described later in the Example Implementations section.

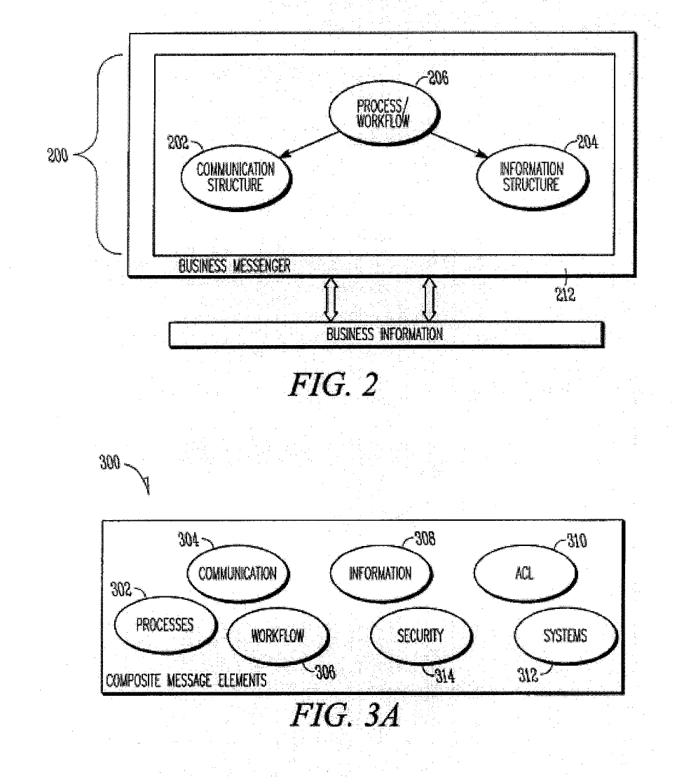

A business process, such as business processes 101a-101n, includes a series of communications between business process groups. Business messages are associated with the series of communications between the business process groups as further described by reference to FIG. 2 below. The business messages drive (i.e., guide, control and direct) the flow of communications. As a result, the novel method of business process messaging described herein is organized around the flow of communication associated with a business process. This novel method of business process messaging is referred to here in as “communication-based business process messaging.”

FIG. 2 is a diagram of an example business message for use within the business process hierarchy shown in FIG. 1. The business message 200 is used to implement communication-based business process messaging within the business process hierarchy 100 in FIG. 1. In one embodiment, the business message 200 comprises a communication structure 202, an information structure 204, and process/workflow information 206.

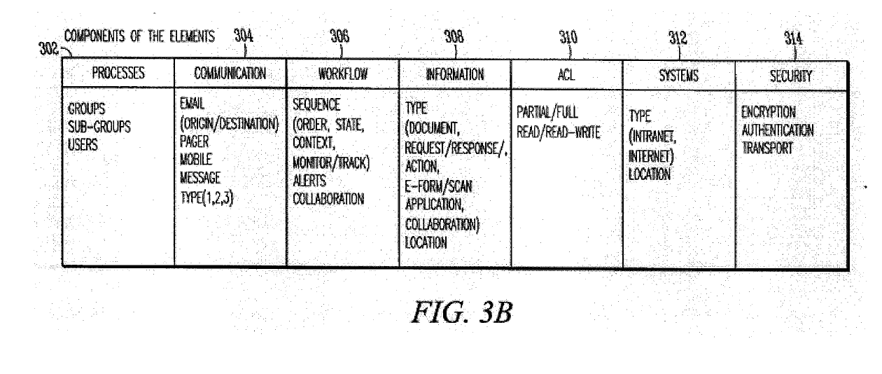

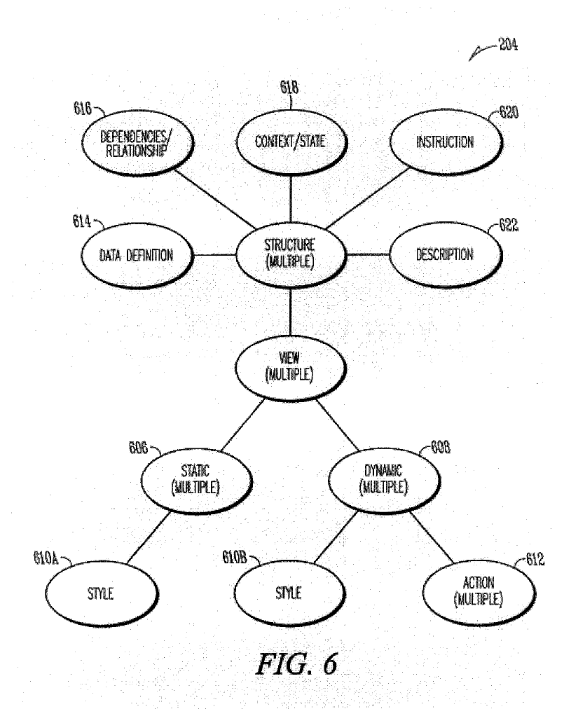

The communication structure 202 defines the communication aspects of a business message. The communication structure 202 comprises information about requests, responses, and associated actions. The communication structure 202 is described in more detail by reference to FIGS. 3A and 3B. The information structure 204 comprises information resources including business information containers. Business information containers are described in more detail in by reference to FIG. 3A, FIG. 3B and FIG. 6. The process/workflow information 206 comprises information about the business process itself as well as information about the operational aspects of the business process (e.g., scheduling, tracking, monitoring, archiving and so on of business messages for a business process). The process/workflow information 206 is described in more detail by reference to FIGS. 3A and 3B.

In one embodiment, the request/response paradigm of a business message is implemented as a novel application program. The application program is a messenger-type program and is shown as a business messenger 212 in FIG. 2. The business messenger 212 is a software application that permits participants in a business process to capture within an electronic communications session the actions and responses for a particular business process using the communication structure 202. The electronic communications session also provides the ability for the participants to take the action needed using the information structure 204. The business messenger also provides access to business information containers using the information structure 204.

FIG. 3A is a diagram of a composite message data structure used to implement a business message 200 (shown in FIG. 2) according to an example embodiment. A composite message 300 is a data structure that defines the components of a business message 200 (shown in FIG. 2). In one embodiment, the composite message 300 comprises a processes component 302, a communication component (also called a communication structure) 304, a workflow component 306, an information component (also called an information structure) 308, an access control list (“ACL”) 310, a system component 312, and a security component 314. A composite message 300 is not limited to the components shown in FIG. 3A. In alternate embodiments, a composite message 300 may have additional or differing components. The additional or differing components may be any information related to a business process including, but not limited to, additional information related to what the business process is, how the business process is carried out, and who is involved in the business process.

Each one of the components of the composite message 300 shown in FIG. 3A is described below by reference to both FIG. 3A and FIG. 3B. FIG. 3B is a table listing examples for each of the components of the composite message shown in FIG. 3A according to an example embodiment.

As shown in FIG. 3A, the processes component 302 of the composite message 300 defines one or more business processes. As defined above by reference to FIG. 1, the term “business process” refers to a collection of related activities (e.g., requests, responses, alerts and so on), information resources (e.g., documents, messages, systems, applications and so on), and users/people (including inter/intra business process functional groups/subgroups) that produce a specific outcome. As shown in the table in FIG. 3B, some examples of the elements of a business process defined by the processes component 302 of the composite message 300 may include, but are not limited to, process groups, subgroups, and users.

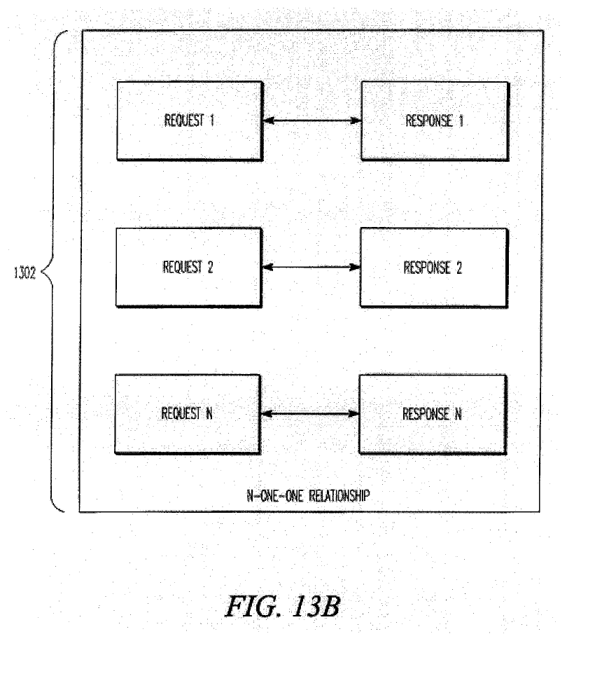

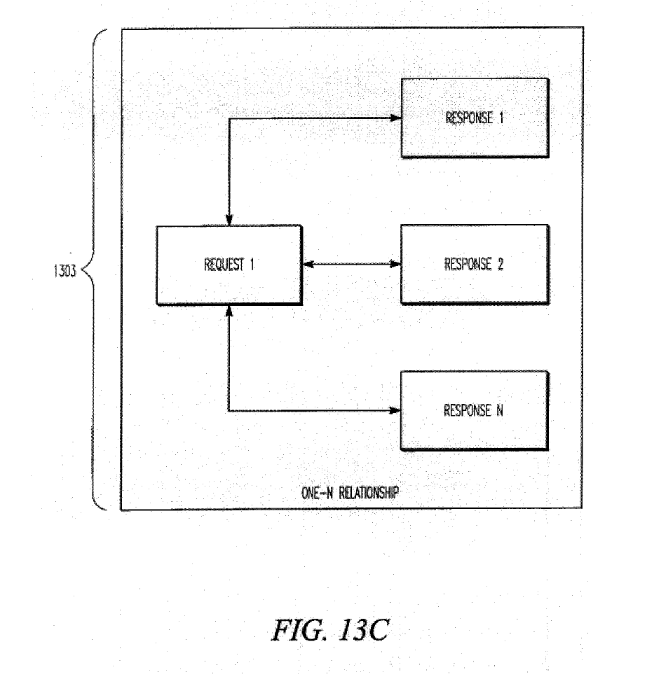

As shown in FIG. 3A, the communication component 304 of the composite message 300 defines communication exchanges between the process users. In some embodiments, the communication exchanges may be conducted using an e-mail system. However, embodiments of the invention are not limited to e-mail as a mode of communication. In alternate embodiments, communication exchanges may be conducted all or in part using any communication mode including, but not limited to, pagers, facsimile machines, video and/or audio conferencing, text messaging (e.g., Short Message Service (SMS)), instant messaging, voice over Internet Protocol (VoIP), chat sessions, mobile phones or any other type of wireless device and so on. The communication component 304 also defines a “communication structure” such as communication structure 202 in FIG. 2. The communication structure defines the request and response arrangement for the communication exchange between process users. In one embodiment, the communication exchanges associated with a communication structure may be one of the following example types. First, the communication exchange may involve one request and one response (referred to as “Type 1”). Second, the communication exchange may involve a series of requests and responses with each request having only one response (referred to as “Type 2”). Third, the communication exchange may involve one request and multiple responses (referred to as “Type 3”). These three example types of communication exchanges are described in more detail by reference to FIGS. 13a, 13b, and 13c. Thus, as shown in the table in FIG. 3B, the communication component 304 comprises anything needed to define a communication exchange including, but not limited to, the mode of communication, the origin and destination(s) for the communication exchange, and type of communication.

As shown in FIG. 3A, the workflow component 306 of the composite message 300 defines the operational aspects of a business process. In other words, the workflow component 306 monitors the progress of a business process. As shown in the table in FIG. 3B, the workflow component of the composite message may include, but is not limited to, a sequence for the tasks to be performed (the sequence including an order for the tasks, a state of completion for the tasks, a context in which the tasks are performed, and monitoring and tracking functions for the tasks), alerts and/or notifications for process users, collaboration tools for completing the tasks, and so on.

As shown in FIG. 3A, the information component 308 of the composite message 300 defines existing information resources as well as customized data structures that can be used to pass business information. The customized data structures are also referred to as “business information containers.” Business information containers are described in more detail by reference to FIG. 5. A business information container is an instance of an “information structure.” Information structures are described in more detail by reference to FIG. 6. As shown in the table in FIG. 3B, the information component 308 of the composite message may be, but is not limited to, information about a type of information resource or a location of a resource. Examples types of information resources include, but are not limited to, documents, forms, applications, collaborative tools (e.g., video conferencing, chat and instant messaging, document collaboration, and online whiteboards) and so on. The information component 308 of the composite message may also include the content contained within a communication structure (such as communication structure 202 shown in FIG. 2) including the actual content representing the request, the response or the action.

As shown in FIG. 3A, the access control list component 310 of the composite message 300 defines filters for the information in the business message that is to be presented to a process user. As shown in the table in FIG. 3B, the access control list component 310 of the composite message may include, but is not limited to, partial or full access to the components of the business message, and read only or read/write access to the components of the business message.

As shown in FIG. 3A, the systems component 312 of the composite message 300 define the location of and access to systems for use in the business process. As shown in the table in FIG. 3B, the systems component of the composite message may include, but is not limited to, information about various systems (both intranet and Internet based systems). Some examples of systems include document servers, application servers, workflow servers, or any other networked host which can provide business information.

As shown in FIG. 3A, the security component 314 of the composite message 300 defines security tools for the business process. As shown in the table in FIG. 3B, the security component of the composite message may include, but are not limited to, encryption, authentication, and transport tools.

The business message 200 (shown in FIG. 2) is an instance of the composite message 300. To create a business message, a subset of the components in the composite message 300 are selected as desired based on the communications in a particular business process. The composite message 300 may be viewed as a master list of elements available for use in building a business message 200. The composite message elements available to choose from when creating a business message 200 can be expanded or changed without changing the overall system for communication-based business process messaging. The composite message data structure is merely updated to reflect the new or changed elements. Thus, the composite message is a data structure providing a common interface between different modes of communication within a business process. Although described as a single data structure, a composite message is not limited to a single data structure. In alternate embodiments, a composite message may be created using more than one data structure for the components of the composite message. For example, but not by way of limitation, each of the components shown in FIG. 3A may be created using separate relational databases.

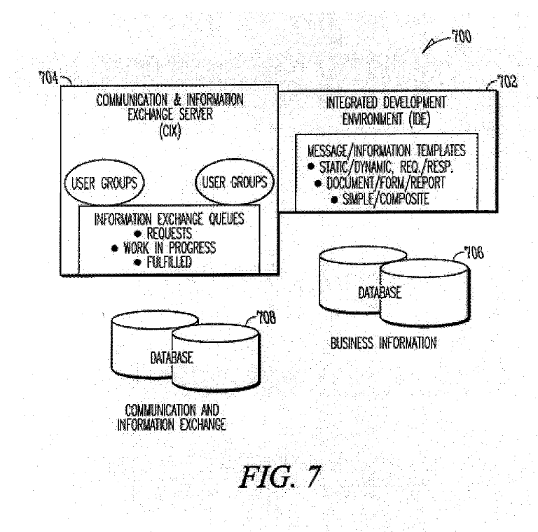

In another embodiment, the components of a composite message described above are defined using an Integrated Development Environment (“IDE”). In one embodiment, the IDE is a software tool that integrates information and creates business messages for use in a communication-based business messaging system. The IDE is described in more detail by reference to FIGS. 7, 8, 9, 10, and 11 below.

In one embodiment, the components of a composite message described above are defined using an Integrated Development Environment (“IDE”). In one embodiment, the IDE is a novel software tool that integrates information and creates business messages for use in a communication-based business messaging system. The IDE is described in more detail by reference to FIGS. 7, 8, 9, 10, and 11 below.

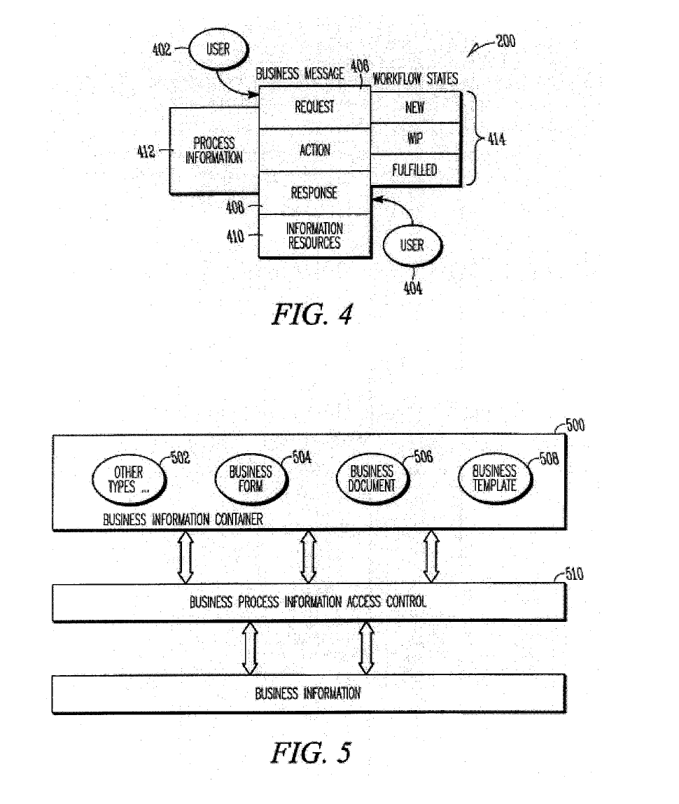

FIG. 4 is an example of a communication exchange using a business message. The business message may be in the form of an electronic mail (e-mail) message for example; however, business messages are not limited to e-mail messages. Business messages may be any form of communication defined by the composite message used to implement the business message. As shown in FIG. 4, a first process user 402 sends a business message 200 with a request 406 to a second process user 404. The second process user 404 receives the business message 200 with the request 406 and provides a response 408 to the request 406. In some embodiments, the response 408 is an action (i.e., something is done by the second process user 404 as a result of receiving the request 406). Actions may be reference actions and/or submission actions. A reference action may include one or more references to an information resource (e.g., a document, an instruction, a message, a system, an application and so on). A submission action may include one or more embedded application user interfaces. The request 406 and the response 408 are part of a business message 200. In addition to the request 406 and the response 408, the business message includes information resources 410. The information resources 410 may include, for example, a document, instruction, message, system, application and so on needed by the second user 404 in order to provide the response 408. The business message 200 also comprises process information 412 and workflow states 414. The process information 412 defines the process. The workflow states 414 allow the status of the business message to be tracked. In the example shown in FIG. 4, the workflow states 414 are “new” message, “wip” work in progress, and “fulfilled” request.

The example communication exchange shown in FIG. 4 is an example of a simple type of business message. Simple messages are one type of business message. In one embodiment, a simple message has one request 406 and one response 408. Simple message are described in more detail by reference to FIGS. 13a, 13b, and 13c. Communication exchanges according to embodiments of the invention may include other types of business messages such as the message types described later by reference to FIGS. 13A, 13B, and 13 C.

The example business message 200 shown in communication exchange in FIG. 4 was created using a data structure such as the composite message 300 shown in FIG. 3A. The first process user 402 creates the business message 200 by selecting the elements of a composite message 300 shown in FIGS. 3A and 3B that are applicable to a particular business process communication situation. The communication component 304 of composite message 300 is selected and defines the request 406 and response 408 arrangement for the business message. The information component 308 of composite message 300 is selected and defines the actual content of the request, the response and the action as well as any other information resources 410 needed to for the response 408. The processes component 302 of composite message 300 is selected and defines users (i.e., first process user 402 and second process user 404) for the business process. The workflow component 306 of composite message 300 is selected and defines a sequence for tasks to be performed according to the business process. The sequence information includes workflow states 414. The example business message 200 shown in FIG. 4 includes the following components of a composite message data structure: a process component 302, a communication component 304, a workflow component 306 and an information component 308. Although not shown in the example business message 200 shown in FIG. 4, any of the following additional components of a composite message data structure may have also been included: an access control list component 310, a systems component 312, and a security component 314.

FIG. 5 is a block diagram illustrating types of business information containers according to an example embodiment. The business information container 500 is a data structure capable of holding multiple objects of information. The business information container 500 is an information structure that contains business information data and/or content. (Information structures are described in more detail by reference to FIG. 6). The business information container 500 is flexible enough to accommodate the exchange of different kinds of information as part of the communications during a business process. Information that can be exchanged includes both static content and dynamic content. The business information container 500 may include, but is not limited to, the following information: a business form or electronic form 504, a business document 505, a business template 508, or any other types of information containers 502. The business information container is associated with business process information access control 510 (i.e., an access control list). The access control list 510 filters the information in the business information container 500 that is made available to a process user. The business information container 500 intelligently provides a particular process user with only the business information or programs 512 that are needed by the particular process user according to the access control list 510.

FIG. 6 is a block diagram of an information structure within the composite message shown in FIG. 3A according to an example embodiment. In one example, the information structure is information structure 204 of business message 200 shown in FIG. 2.

As shown in FIG. 6, the information structure 204 includes static content 606 and a dynamic content 608. The static content 606 includes information that does not change as a part of the business process. An example of static content 606 is a message or a report. The dynamic content 608 includes information that can change as part of the business process. The dynamic content 608 may include one or more actions 612. A submission is an example of one type of an action. An example of a submission action is an electronic form. An electronic form is a user interface to an application program that is part of the business process. The electronic form may be either embedded in the information structure 204 or referenced with a Uniform Resource Locator (URL) or other location identifier.

The information structure 204 shown in FIG. 6 also includes a style 610a, 610b. The static content 606 has a particular style 610a and the dynamic content 608 has a particular style 610b. The style 610a, 610b is either a pre-defined format or a user-specified format for particular types of static content 606 and dynamic content 608. The style 610a, 610b includes aesthetic characteristics such as font type, font size, color and so on. The style 610a, 610b also includes transformation information to convert static or dynamic content from one format to another format (e.g., to convert from HTML to PDF, to convert text to HTML, and so on).

In addition, the information structure 204 also includes data definitions 614, dependencies/relationships 616, context/state information 618, instructions 620, and a description 622. The dependencies/relationships 616 define rules such as mappings (an example of such mappings may include, but is not limited to, metadata mappings) and/or macros between data fields within an information structure 204 or across information structures 204. The dependency/relationships 616 also define rules for data type dependencies.

The information structure 204 shown in FIG. 6 is a component of a business message 200 exchanged by a business messenger 212. The information structure 204 allows for information exchanges between the relevant process users.

FIG. 7 is a block diagram of a system for communication-based business process messaging according to an example embodiment. The system 700 shown in FIG. 7 comprises an integrated development environment (IDE) 702 and a communication and information exchange server (CIX) 704. The IDE 702 and the CIX 704 comprise program modules to implement communication-based business process messaging. Generally, program modules include routines, programs, objects, components, data structures, etc., that perform particular functions or implement particular abstract data types.

The IDE 702 provides a mechanism to define a business process as well as to define the information that is part of a workflow for a business process. The IDE 702 is also used to create and publish business information containers that may be part of a communication exchange. The communication structure comprises the requests and responses for a particular business process. The business information container is an information structure that may include both static content and dynamic content for a particular business process. As described by reference to FIG. 6, the business information container may contain different types of information. Some examples of information include messages, templates, documents, reports and electronic forms. The IDE 702 integrates all of the information together that makes up a particular business process. In one embodiment, the information for the particular business process is saved in a business information database 706. The IDE may be a tool used to define a composite message. The IDE defines the composite message so that the CIX may orchestrate that message. The rules created by the IDE and laid out in the composite message create an information assembly line and gives the CIX instructions as to how to manage that assembly line. Put briefly, the output of the IDE 702 is the input to the CIX 704.

The CIX 704 provides a mechanism for managing communications and the information exchange during the business process. The CIX 704 controls the business process in the manner defined by the IDE 702. The CIX 704 creates and maintains information exchange queues for the process users in a business process groups. For example, the information exchange queues track requests, work in progress, and work fulfilled. In one embodiment, the information managed by the CIX 704 is stored in a communication and information exchange database 708.

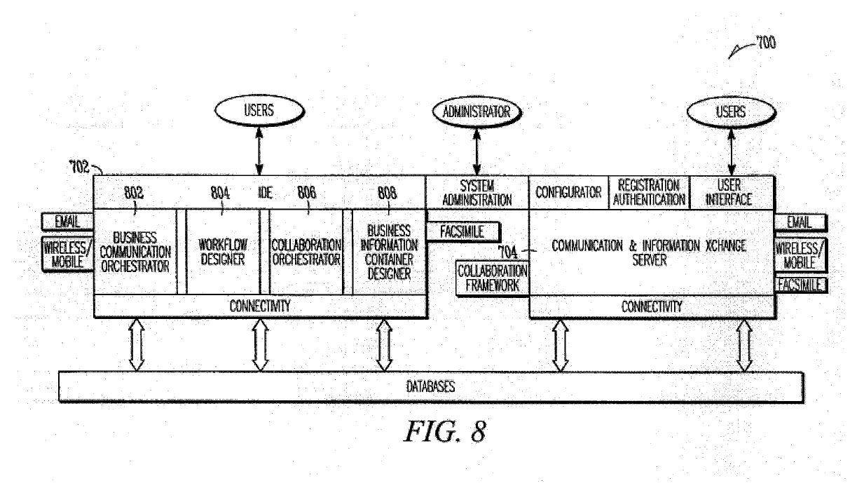

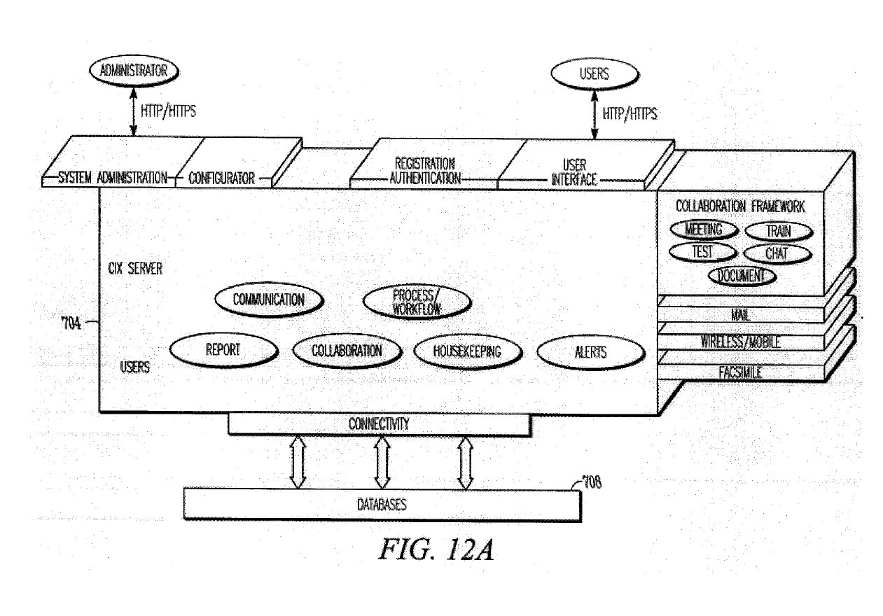

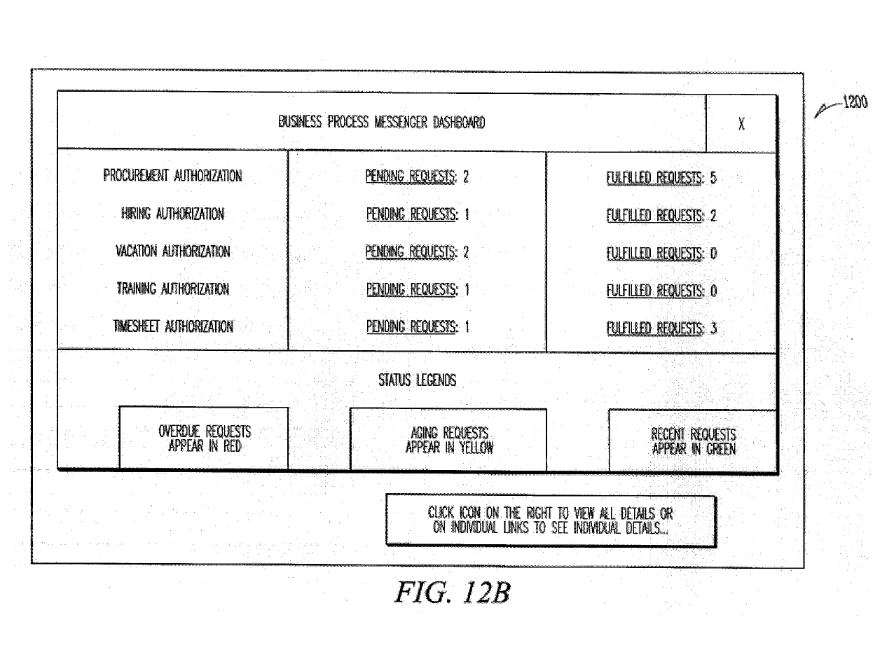

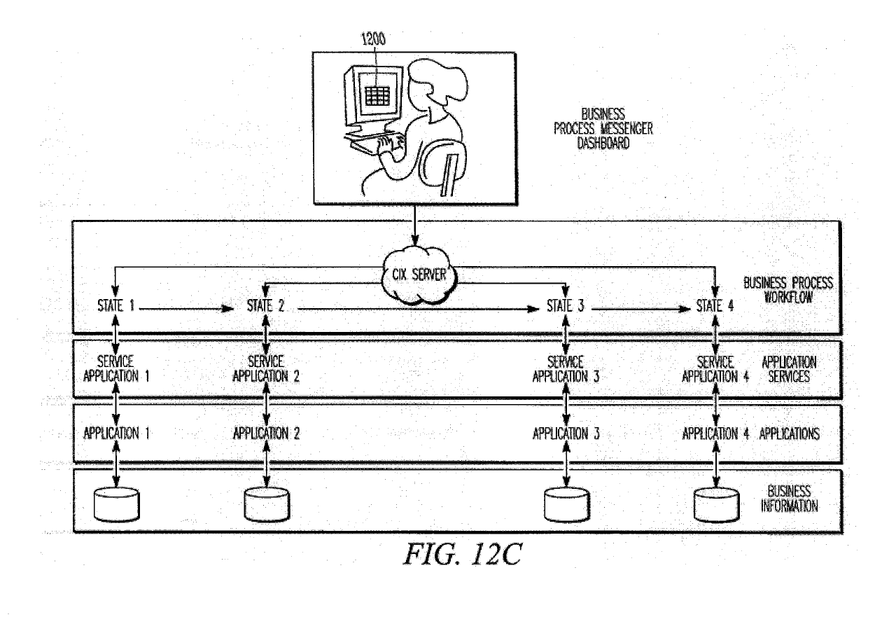

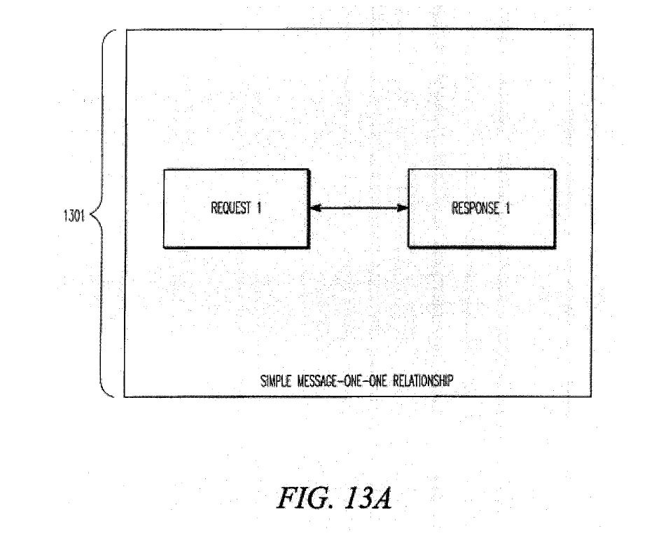

FIG. 8 is a more detailed block diagram of the system shown in FIG. 7 according to an example embodiment. The system 700 shown in FIG. 8 comprises an integrated development environment (IDE) 702 and a communication and information server (CIX) 704. A more detailed block diagram of the CIX 704 is shown in FIG. 12.

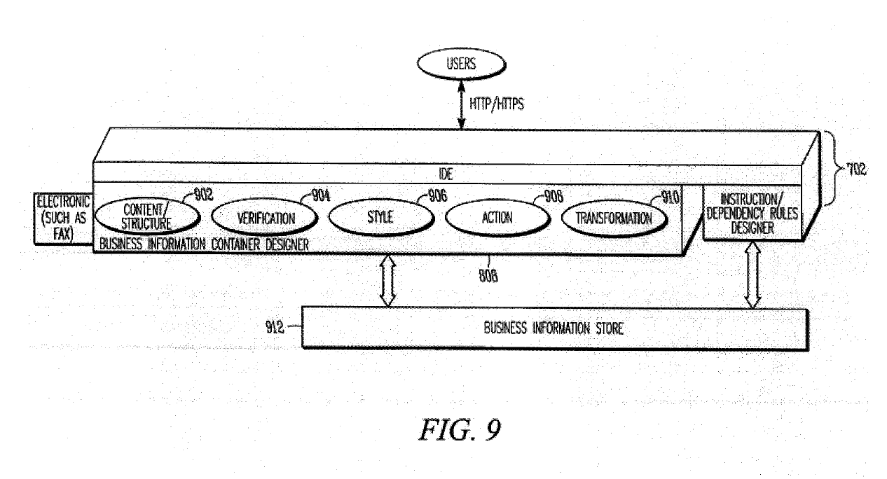

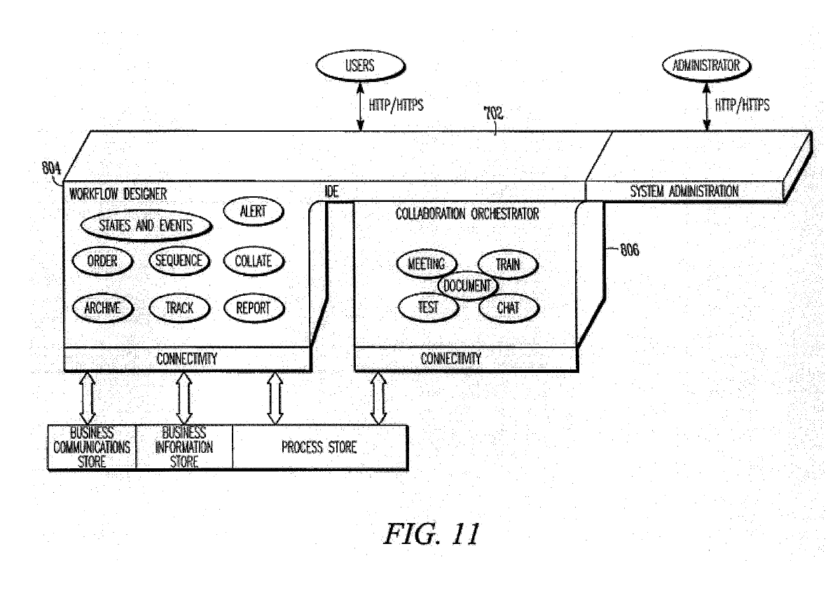

In one embodiment, the IDE 702 comprises four modules: a business communication orchestrator 802, a workflow designer 804, a collaboration orchestrator 806, and a business information container designer 808. The business communication orchestrator 802 of the IDE 702 provides a mechanism to orchestrate the communication part of the business message. In one embodiment, the business communication orchestrator 802 provides the communication component 304, the process component 302, the access control list 310, and the security component 314 of a composite message 300 (shown in FIG. 3A). A more detailed block diagram of the business communication orchestrator 802 is shown in FIG. 7. The workflow designer 804 of the IDE 702 shown in FIG. 8 provides a mechanism to assemble to the business workflow/sequence through which messages and document flow through. In one embodiment, the workflow designer 804 provides the workflow component 306 of a composite message 300 (shown in FIG. 3A). A more detailed block diagram of the workflow designer 804 is shown in FIG. 11. The collaboration orchestrator 806 of the IDE 702 shown in FIG. 8 provides a mechanism to integrate collaboration tools with the workflow. A more detailed block diagram of the collaboration orchestrator 806 is shown in FIG. 8. The business information container designer 808 of the IDE 702 shown in FIG. 7 provides a mechanism to build a business information container. In one embodiment, the business information container designer 808 provides the information component 308 and the systems component 312 of a composite message 300 (shown in FIG. 3A). A more detailed block diagram of the business information container designer 808 is shown in FIG. 9.

The system for automating and integrating a business process shown in FIG. 8 also includes e-mail interfaces, wireless mobile interfaces, system administration tools (including configuration tools and registration/authentication tools) as well as customized user interfaces. The system in FIG. 8 may also include facsimile interfaces and a collaboration framework. The system 700 also stores business information and application data in one or more databases.

FIG. 9 is a more detailed block diagram of the business information container designer 808 shown in FIG. 8 according to an example embodiment. The business information container designer 808 is part of the IDE 702. The business information container designer 808 comprises a content/structure manager 902, a verification manager 904, a style manager 906, an action manager 908 and a transformation manager 910. The content/structure manager 902 provides a mechanism to define a structure for a business information container. As described above by reference to FIG. 6, the structure includes static content and a dynamic content. The verification manager 904 provides a mechanism to verify the structure of the business information container. The style manager 906 provides a mechanism to define style for a container. Static content in a business information container has a particular style and dynamic component in a business information container has a particular style. The styles are defined by the style manager 906. The action manager 908 provides a mechanism to define an action in a business information container. An action may include submissions and/or references and/or validations. The transformation manager 910 provides a mechanism to transform information to a specified format (e.g., publish in HTML, PDF etc., or convert from text to HTML, HTM to PDF etc.). The business information container designer stores data in a database (also called a business information store) 912. The components of the business information container designer 808 (i.e., the content structure manager 902, the verification manager 904, the style manager 906, the action manager 908 and the transformation manager 910) design, collect, manage and aggregate business information containers in a business information store. As a result, the business information container functions as a structure around business information which is to be exchanged as part of business process messaging.

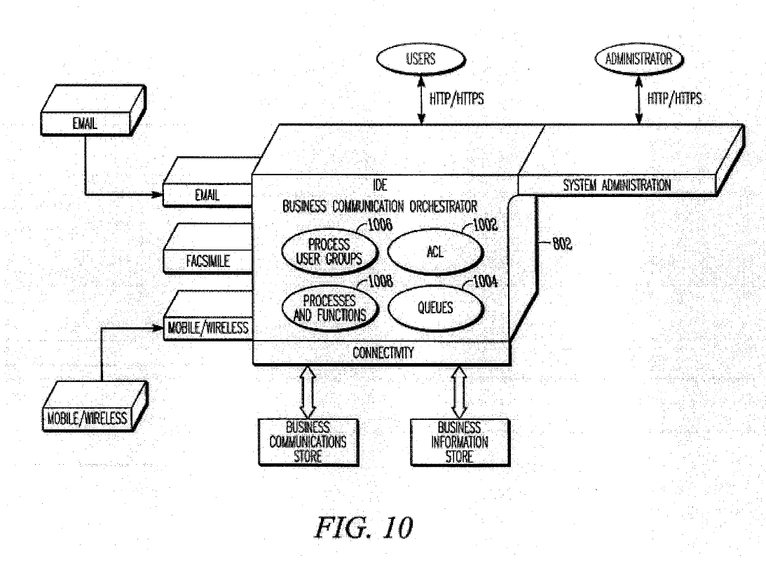

FIG. 10 is a more detailed block diagram of the business communication orchestrator 802 shown in FIG. 8 according to an example embodiment. The business communication orchestrator 802 is part of the IDE 702. The business communication orchestrator 802 shown in FIG. 10 comprises an access control list (ACL) 1002, queues 1004, process user groups 1006, and processes and functions 1008.

The access control list 1002 is a mechanism to control the portion of a business message that a user sees/has access to. For example, a business message may include a 30-page document; however, one of the process users may only need to access the first page of the document. The access control list controls what information is presented to a process user. Only information that is relevant to a particular user is presented to the user. The queues manager 1004 provides a mechanism to create queues to track the work in progress for a particular business process. The process user groups manager 1006 provides a mechanism to define the people who are part of a particular business process. Process user groups are also referred to as business process groups in this detailed description. The processes and functions manager 1008 provides a mechanism to defines the business process itself. The business communication orchestrator 802 shown in FIG. 10 also includes e-mail interfaces, wireless/mobile interfaces, and facsimile interfaces, as well as system administration tools. The business communication orchestrator 802 also stores business information and communications data in one or more databases.

Thus, the business communication orchestrator 802 provides manages process users, process groups, and information. The business communication orchestrator 802 also intelligently associates messages with access controlled information, resources, and/or business applications. As a result, process users no longer receive more information than required, redundant information, irrelevant actions, and inaccurate or partial information.

FIG. 11 is a more detailed block diagram of the workflow designer 804 and the collaboration orchestrator 806 shown in FIG. 8 according to an example embodiment. Both the workflow designer 804 and the collaboration orchestrator 806 are part of the IDE 702.

The workflow designer 804 comprises tools to create alerts for business messages. The workflow designer 804 also comprises tools to order, archive, sequence, track and collate business messages. The workflow designer 804 also comprises tools to monitor states and events that cause state changes for a business message. Additionally, the workflow designer also comprises tools for creating reports related to the business messages. Process users no longer use unstructured and ad-hoc requests and responses in the business process workflow. The workflow designer 804 aids in integrating the communications with the business process. As a result, the workflow designer 804 provides several useful results including common scheduling, process tracking and monitoring, information versioning, communications archiving for history and audit trails and reporting (performance, contextual-correlations, process state, etc.)

The collaboration orchestrator 806 comprises a mechanism for integrating with on-line meeting and conference collaboration frameworks (including frameworks for chat sessions), a mechanism for integrating with testing and training frameworks, a mechanism for integrating with document collaboration and workflow frameworks. The collaboration orchestrator 806 integrates into the business process existing tools for meetings, presentations, chats, testing, training, documentation collaboration and so on. Process users no longer have to identify and use disparate systems to fulfill process requests. Rather, the systems and information resources are integrated with the business message.

Both the workflow designer 804 and the collaboration orchestrator 806 stores business information and communications data in one or more databases.

FIG. 12A is a more detailed block diagram of the communication and information server (CIX) 704 shown in FIG. 7 according to an example embodiment. The CIX 704 controls the business process in the manner defined by the IDE (element 702 shown in FIG. 7). The CIX 704 controls the communication and information sharing, manages the workflow for a business process, integrates with collaboration frameworks, integrates triggers and alerts for business process notifications and actions, provides reports and other housekeeping functions. The CIX 704 also integrates with wireless/mobile, e-mail, and facsimile frameworks. In one embodiment, the information managed by the CIX 704 is stored in a communication and information exchange database 708. The CIX 704 streamlines the business process communication and information exchanges.

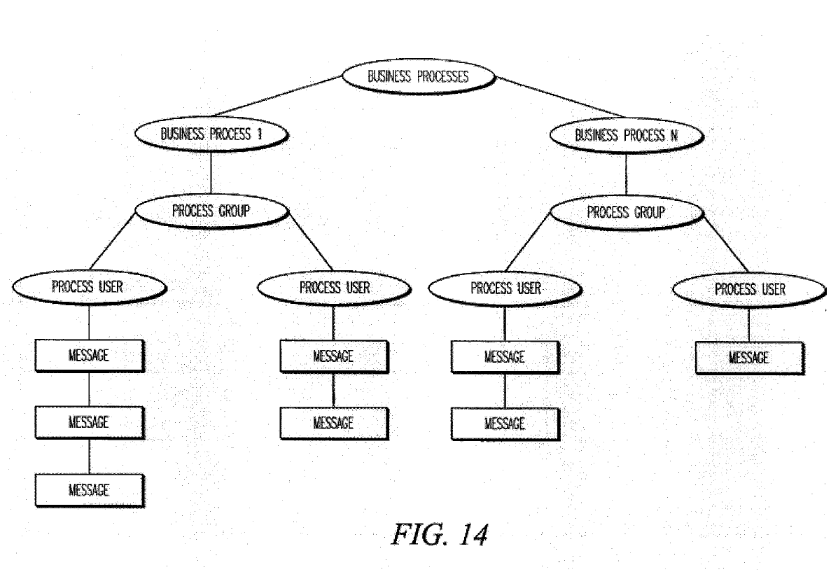

In one embodiment, the communication and information exchange server is a novel application program that manages a communication workflow for a business process. The communication workflow defines a sequence for the tasks to be performed as part of the business process. The communication and information exchange server may also maintain business message queues. The business message queues are data structures used to manage the communication workflow. Each message in the business message queue may have a state of completion (e.g., new, in progress, fulfilled, and so on). As the communication workflow progresses, the state of the message changes. An example of business message queues used by the CIX 704 to manage workflow is provided in FIG. 14. The communication and information exchange server may also trigger changes within the communications workflow. For example, the communication and information exchange server may trigger an action, an event, a notification, an alert and the like. In addition, the communication and information exchange server may provide scheduling functions for the communication workflow. Additionally, the communication and information exchange server may provide communication logging, reporting, and/or auditing functions. Some examples of communications workflows are described later in the Example Implementations section.

In addition to the IDE and CIX software tools, some embodiments of the invention also include a user interface for tracking the status of one or more business processes. A Business Process Messenger Dashboard (“dashboard”) is a custom user interface that displays a synopsis of one or more business processes or select parameters within business processes. The dashboard is an alert, notification, reporting, and tracking mechanism for all business process communications. The dashboard integrates information from multiple business processes into a unified display. In one embodiment, the dashboard receives the status information by communicating with a program that manages the communications workflow for a business process such as a communication and information exchange server.

For example, FIG. 12B illustrates an example user interface for a dashboard. In the example shown in Figure x, the dashboard 1200 displays information related to five different business processes. The five different business processes are the following: procurement authorization, hiring authorization, vacation authorization, training authorization, and a time sheet authorization. The dashboard 1200 displays a synopsis of these five business processes in the single display shown in FIG. 12B. In one embodiment, the dashboard 1200 updates and displays the status information in real-time. In another embodiment, the dashboard updates and displays the information after polling the server for changes. The status information for the business process includes any information used to track or to monitor the progress of a business process.

In the example shown in FIG. 12B, the status information comprises a number of pending requests for a business process and a number of fulfilled requests for a business process as well as an alert mechanism to identify requests that are recent, aging, or overdue. The status information that is displayed is a synopsis of more detailed information that available about the business process. The status information displayed may provide a link back to applications or additional information. However, embodiments of the invention are not limited to the status information shown in FIG. 12B. In some embodiments, the status information displayed in the synopsis is customizable by system administrators or by individual users.

Although not shown in FIG. 12B, the dashboard 1200 may also display notifications associated with at least one of the one or more business processes. The notifications may be frequency-based, time-based or event-based. One example of a frequency-based notification is a notification that occurs at defined intervals (e.g., every 24 hours). One example of a time-based notification is a notification that occurs at a specific time (e.g., 10 AM on Monday). One example of an event-based notification is a notification that occurs when something has happened (e.g., change in a workflow state or upon the arrival of a document).

The dashboard 1200 may also display alerts associated with the business process. In some embodiments, the alerts are indicated with color-coding. For example, in the example shown in FIG. 12B, the number of pending requests may be color-coded to indicate alerts. For example, if a pending request link is green, it may indicate a recent request. If a pending request link is yellow, it may indicate an aging request. If a pending request link is red, it may indicate an overdue request. Alternatively, alerts may comprise an alarm to inform a user of a particular condition. In one other embodiments, alarms may be frequency, time or other event based.

Embodiments of the invention are not limited to the example user interface for a dashboard 1200 shown in FIG. 12B. A user interface for a Business Process Messenger Dashboard may organize and presents information in any way that provides a synopsis of the business process communications activities. The user interface may be customizable by system administrators or individual users.

FIG. 12C is a block diagram of an example embodiment of a communication-based business process messaging system comprising a synopsis view of the business process communications activities. The synopsis view may be a dashboard such as the example dashboard shown in FIG. 12B. As shown in FIG. 12C, the dashboard 1200 communicates with a communication and information exchange (“CIX”) server (or service) to receive status information for a business process. As described above by reference to FIG. 12, the CIX manages the communication workflow for a business process. In the example shown in FIG. 12C, the CIX maintains business message queues to manage the communication workflow. The workflow layer communicates with the applications services layer. The application services access the applications in the next layer and the applications access a layer of business information as needed for the business process.

An overview of a system for communication-based business process messaging has been presented by reference to FIGS. 1-12. The system for communication-based business process messaging automates and integrates business processes using communication and information sharing techniques. The system utilizes a novel composite message data structure providing a common interface between different modes of communication within a business process. The composite message has been described by reference to FIGS. 2, 3A, 3B, 4, 5 and 6. The components of a composite message may be defined using a novel software tool (referred to herein as an Integrated Development Environment (“IDE”)) that integrates information and creates business messages for use in a communication-based business messaging system. The IDE has been described by reference to FIGS. 7, 8, 9, 10, and 11. In addition a novel software tool that manages a communication workflow for a business process (referred to herein as a communication and information exchange server (“CIX”)) has been described by reference to FIG. 12. Finally, a novel a user interface that displays a synopsis of one or more business processes has been described by reference to FIGS. 12B and 12C.

### Method Embodiments

According to example embodiment of the invention, a business process can be viewed as a sequence of exchanges of business messages between functional groups in an inter or intra business process. Composite messages are data structures used to implement business messages. Business messages drive the business process. The business messages may include a request, a static and/or dynamic response (set up by process user(s)) and the associated information and action resources required to fulfill this request.

FIGS. 13a, 13b and 13C are diagrams of example types of business messages. Embodiments of the invention include, but are not limited to, the three types of business messages (Type 1, Type 2, and Type 3) shown in FIGS. 13a, 13b, and 13c. FIG. 13a is a block diagram of a business message of Type 1 according to one embodiment. The business message 1301 shown in FIG. 13a has a one-to-one relationship between the request and the response. In other words, for each request, there is one response. A business message of Type 1 is also referred to as a simple message.

FIG. 13b is a block diagram of a business message of Type 2 according to one embodiment. The business message 1302 shown in FIG. 13b has many one-to-one relationships between the requests and the responses. In other words, a Type 2 message has two or more request/response pairs (e.g., Request 1 and Response 1), but for each individual request that is part of the business message, there is one response.

FIG. 13c is a block diagram of a business message of Type 3 according to one embodiment. The business message 1303 shown in FIG. 13b has a one-to-many relationship between the request and the responses. In other words, for each request, there are two or more responses.

The example business messages 1301, 1302, 1303 shown in FIGS. 13a, 13b, and 13c may be implemented using a data structure referred to herein as a composite message. The composite message is structured in such a way that a process user who receives a request is only exposed to the portion of the business message that the process user needs to respond to. If there are multiple responses needed (such as in the Type 2 and Type 3 business messages shown in FIGS. 13b and 13c), the other process users are only exposed to the portions of the communication that they need to respond. However, when multiple responses are required, the process request is not fulfilled until each one of the responses is received.

FIG. 14 is a block diagram of example message queues for a business message in a communication-based business processing messaging system. Messages are maintained in specific queues until the requests are fulfilled. Upon fulfillment of a request, other business messages are generated to advance the workflow of the business process In the example embodiment shown in FIG. 14, each process user in a process group has a message queue. In one embodiment, the business messages in the message queue have states associated with them. The states indicate the status of the request such as pending or fulfilled. The state of a business message changes as the workflow of the business process progresses. That is, there is a notification and a first request, an expected business process action (can be automated), action capture, state change, and trigger to the next notification and request. In an alternate embodiment, a process user may have multiple queues. For example, each process user may have a first queue for new business messages, a second queue for business messages with requests that are in progress, and a third queue for business messages with requests that are fulfilled.

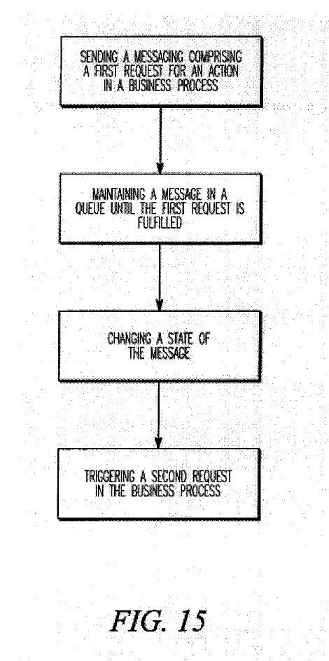

FIG. 15 is a high-level flow chart of a method performed by the example system shown in FIG. 7 according to an example embodiment. As shown in FIG. 15, the method 1500 includes sending a messaging comprising a first request for an action in a business process 1502. Then, the message is maintained in a queue until the first request is fulfilled. After the first request is fulfilled, a state of the message is changed. Also upon fulfillment of request, a second request in the business process is triggered. The actions shown in FIG. 15 may occur either sequentially or in parallel.

In this section, particular methods of example embodiments are described. The methods to be performed constitute computer programs made up of computer-executable instructions. As described above, the workflow of a business process is based on communication. The communication sequence drives the business process. Thus, each step in the communication sequence drives an activity in the business process.

### Example Implementations

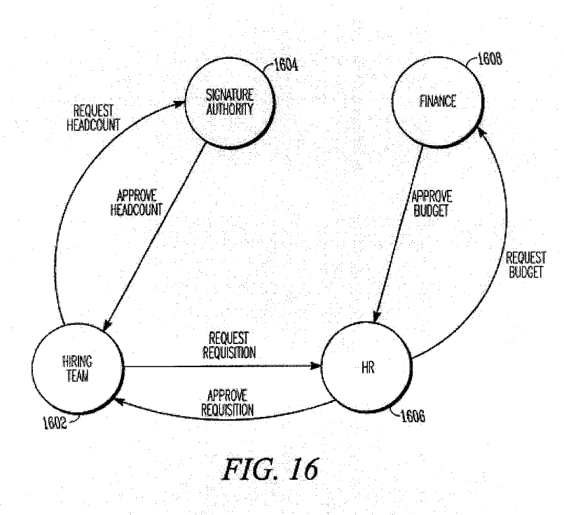

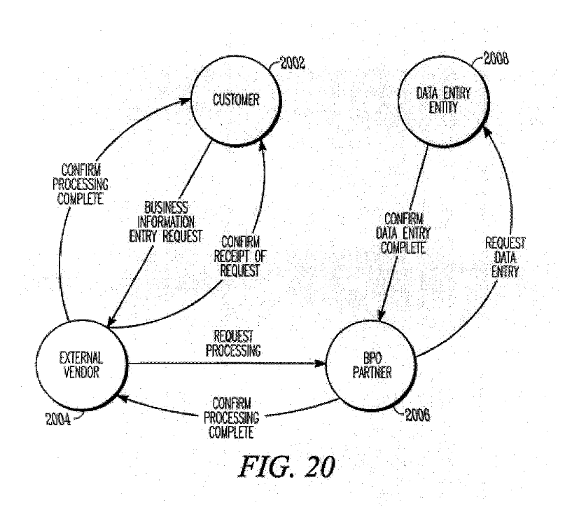

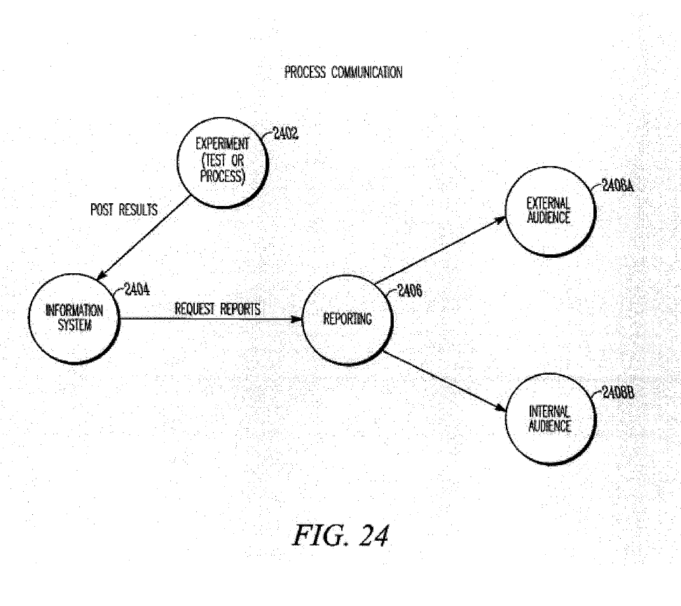

Various examples of systems and methods for embodiments of the invention have been described above. In this section FIGS. 16, 17, 18, 19A and 19B illustrate an example of automating a business process using communication-based business process messaging. FIGS. 20, 21, 22 and 23 illustrate an example of business process outsourcing using communication-based business process messaging. FIGS. 24, 25, 26 and 27 illustrate an example of business reporting using communication-based business process messaging.

Business Automation Example. FIG. 16 is a diagram of an example business process for hiring employees. FIG. 16 illustrates four business entities: a hiring team 1602, a signature authority 1604, a human resources (HR) staff 1606, and a finance team 1608. The process begins when the hiring team 1602 makes a request for a headcount increase to the signature authority 1604 in a particular business unit. Then, the hiring team 1602 receives an approval for the headcount increase. Next, the hiring team 1602 makes a request to HR 1606 for approval of the head count. However, HR 1606 cannot authorize this without contacting the finance team 1608. HR 1606 contacts the finance team 1608 to make sure the budget will accommodate the head count increase. HR 1606 submits the request to the finance team 1608 to see if the head count increase is within the budget. Then, HR receives budget approval from the finance team 1608. After HR receives budget approval, HR 1606 sends back an approval to the hiring team 1602.

In previous systems, the process users in the four business entities shown in FIG. 16 were required to use a variety of systems and information sources to fulfill request such as the requests in this example. In addition to the inefficiency of using disparate systems, these ad hoc requests and responses did not allow for tracking and monitoring the business process.

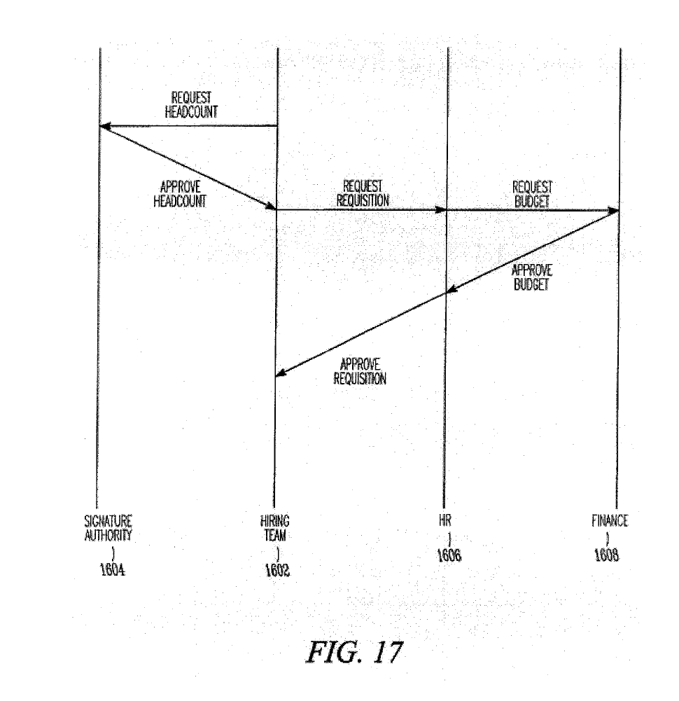

FIG. 17 is a diagram of a communication sequence for the business process shown in FIG. 16. FIG. 13 comprises four vertical lines representing the four business entities shown in FIG. 16 (the hiring team 1602, the signature authority 1604, the human resources (HR) staff 1606, and the finance team 1608). The arrows show the sequence of the communications between the business entities. In the sequence of communications shown in FIG. 17, there are three request/response pairs of communications. The first request/response pair is between the hiring team 1602 and the signature authority 1604. The second request/response pair is between the hiring 1602 and HR 1606. The second request causes HR 1606 to initiate a third request/response pair between HR 1606 and the finance team 1608. After the third request/response pair is complete, the HR 1606 communications with the hiring team 1602 and completes the second request/response pair.

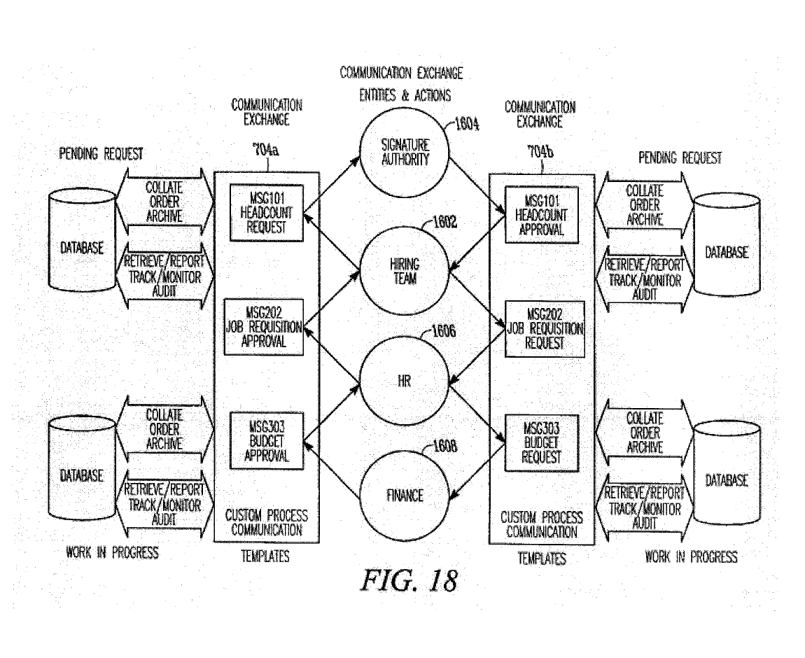

FIG. 18 is a diagram of an example operating environment for the communication sequence shown in FIG. 17 according to one embodiment of the invention. FIG. 18 comprises a first communication and information exchange (CIX) server 704a and a second CIX server 704b. The four business entities involved in the business process (the hiring team 1602, the signature authority 1604, the human resources (HR) staff 1606, and the finance team 1608) send and receive messages through the CIX servers 704a, 704b. The three request/response pairs described by reference to FIG. 17 correspond to three business messages in the operating environment shown in FIG. 18. The business messages include both requests and responses. The business messages are identified by message ids (e.g., MSG101, MSG202, MSG303). The message IDs are associated with process users that are part of the business process. For example, the hiring team 1602 sends MSG101 with a headcount request to the signature authority 1604. The signature authority responds by completing the response in MSG101 and sending the response back to the hiring team 1602. Likewise, MSG202 is sent with a request/response from the hiring team 1602 to HR 1606 and later HR completes the response and returns the response in MSG202 to the hiring team. In addition, HR sends MSG303 with a request/response to the finance team 1608 and the finance team completes the response and returns MSG303 with the response to HR.

The four entities in the business process group (signature authority, the hiring team, HR, finance) are communicating through the CIX servers 704a, 704b. The CIX servers 704a, 704b provide the ability at each point in the communication sequence to collate, order, archive, retrieve/report, track/monitor, and audit requests for work in progress according to example embodiments of the invention.

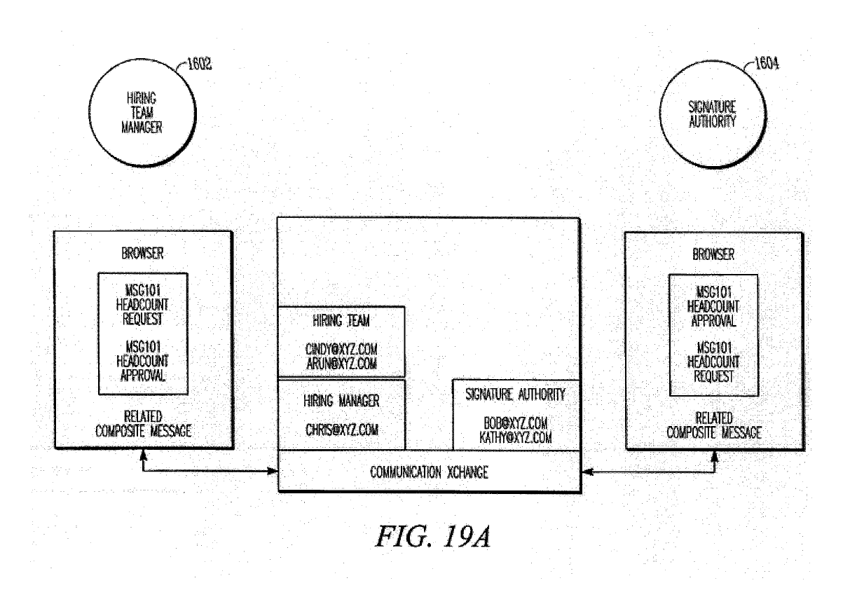

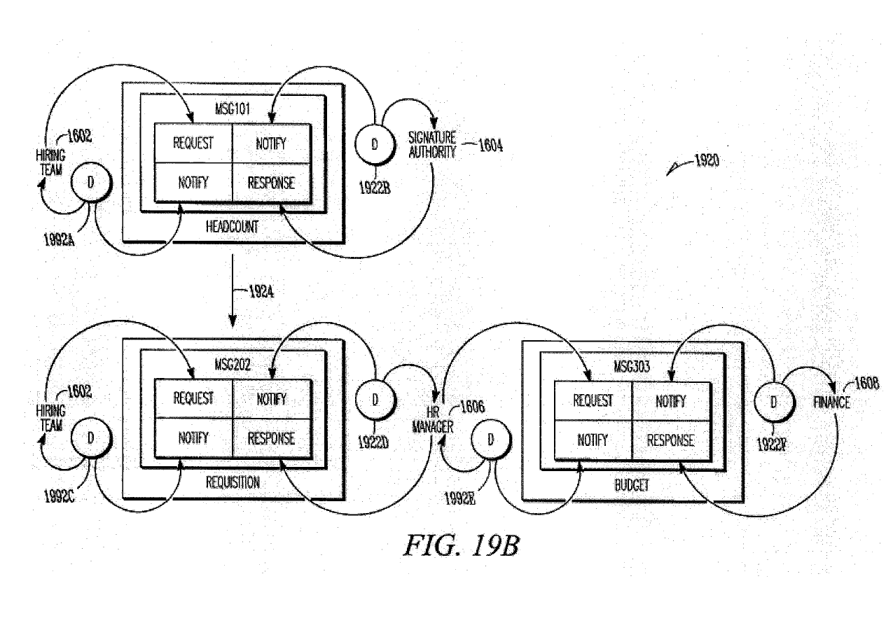

FIG. 19A is a more detailed diagram of the communication sequence for MSG101 shown in FIG. 18 according to one embodiment of the invention. As shown in FIG. 19, MSG101 is a request/response business message that is sent from the hiring team 1602 to the signature authority 1604. The business message has both static and dynamic content. The static content is the headcount request portion of the message. The dynamic content is the headcount approval portion of the message. The signature authority receives both the static and the dynamic content of the business message. The signature authority sends back just the response part of the message (i.e., the MSG101 headcount approval which is illustrated in the box on the top part of the message). All the signature authority has to do is read the request message, fill in the information requested from the hiring team, and send back the communication back to the hiring team. The CIX server provides alerts and scheduling for the communication. For example, if the signature authority fails to respond to the request within a predetermined period of time, the alert may be generated to remind the process users for the signature authority to complete the request.

FIG. 19B is a more detailed diagram of an example embodiment of a communication workflow 1920 for the business process shown in FIGS. 16, 17, 18, and 19A. FIG. 19B also illustrates a Business Process Messenger Dashboard (“dashboard”) to track the business messages in the communication workflow 1920. Each of the entities involved in the business process (the hiring team 1602, the signature authority 1604, the human resources (HR) staff 1606, and the finance team 1608) have a customizable dashboard. The dashboard is represented in FIG. 19B by a circle. The dashboard tracks, provides notifications and alerts, and reports on business communication workflow actions and state changes.

As shown in FIG. 19B, the hiring team 1602 sends a message (MSG101) through a CIX server to the signature authority 1604. The dashboard 1922b for the signature authority 1604 communications with the CIX server to receive business communication workflow actions and state changes for the signature authority 1604. The dashboard 1922b for the signature authority 1604 then displays a synopsis of the information received from the CIX server. In the example shown in FIG. 19B, the dashboard 1922b for the signature authority provides a notification to the signature authority 1922b that a request has been received. The signature authority 1604 then sends a response to the request through the CIX server. When the dashboard 1922a for the hiring team 1602 next communicates with the CIX server, the dashboard 1922a receives a notification that the request is fulfilled (i.e., completed). That notification is displayed on the dashboard 1922a for the hiring team 1602.

Upon completion of the request by the signature authority 1604, a state change occurs in the business communication workflow. A state refers to the status of a business process. For example, the status of the request to the signature authority 1604 was pending until the signature authority 1604 responded. After the signature authority 1604 responded to the request, the status of the request was fulfilled. The fulfillment of a request may trigger a state change in a business process. A state change is represented by an arrow 1924 in FIG. 19B.

In the example embodiment shown in FIG. 19B, the state change begins with the hiring team sending a message MSG202 through a CIX server to the HR manager 1606, the CIX server tracks the request in MSG202 and creates a notification to the HR Manager 1606 indicating that a request is pending. When the dashboard 1922d for the HR manager 1606 updates, the dashboard includes the notification of the new pending request in a synopsis for business process workflow information that is applicable to the HR manager.

After receiving the request in MSG202, the HR manager sends a message (MSG303) to Finance 1608. The message MSG303 includes a request that is tracked by the CIX server. The dashboard 1922f for the Finance group 1608 notifies the Finance group 1608 that a request is pending. If the finance group 1608 does not respond to the request, the dashboard may display alerts (e.g., color coding the requests that are overdue for a response or use alarms) to remind the Finance group 1608 of the pending request. When the finance group 1608 responds to the request, the dashboard for the Finance group 1608 is updated to indicate that the request is fulfilled. When, the dashboard 1922e for the HR manager 1606 receives information that the request in MSG303 has been fulfilled, the dashboard 1922e updates the workflow information to indicate that the request in MSG303 is fulfilled.

Upon fulfillment of the request in MSG303, the HR manager then 1606 responds to the request in MSG202, the CIX server updates status information for the business message MSG202 and creates a notification to the Hiring Team 1602 indicating that the request is fulfilled. When the dashboard 1922a updates its display, the dashboard includes the notification of the fulfilled request in the synopsis of business process workflow information that is applicable to the Hiring Team.

Business Process Outsourcing Example. FIGS. 20, 21, 22 and 23 are diagrams illustrating a business process outsourcing example according to an embodiment. FIG. 20 is a diagram of an example business process for Business Process Outsourcing (BPO). FIG. 20 illustrates four business entities: a customer 2002, an external vendor 2004, a BPO partner 2006, and a data entry entity 2008. The process begins when customer 2002 makes a request for business information entry to external vendor 2004. Then, external vendor 2004 responds to customer 2002 with a confirmation that the information entry request was received and processing will begin. Next, external vendor 2004 makes a request to BPO partner 2006 for processing of the information entry. After BPO partner 2006 receives the processing request from external vendor 2004, BPO partner 2006 makes a request for data entry to data entry entity 2008. Once data entry entity 2008 has entered the data, data entry entity 2008 responds to BPO partner 2006 confirming that the data has been entered. BPO partner 2006 receives the confirmation from data entry entity 2008 and BPO partner 2006 then submits a response to external vendor 2004 confirming that processing is complete. After external vendor 2004 receives confirmation of completed processing, external vendor 2004 responds to customer 2002 confirming that processing of the information entry request is complete.

In previous systems, the process users in the four business entities shown in FIG. 20 were required to use a variety of systems and information sources to fulfill request such as the requests in this example. In addition to the inefficiency of using disparate systems, these ad hoc requests and responses did not allow for tracking and monitoring business processes.

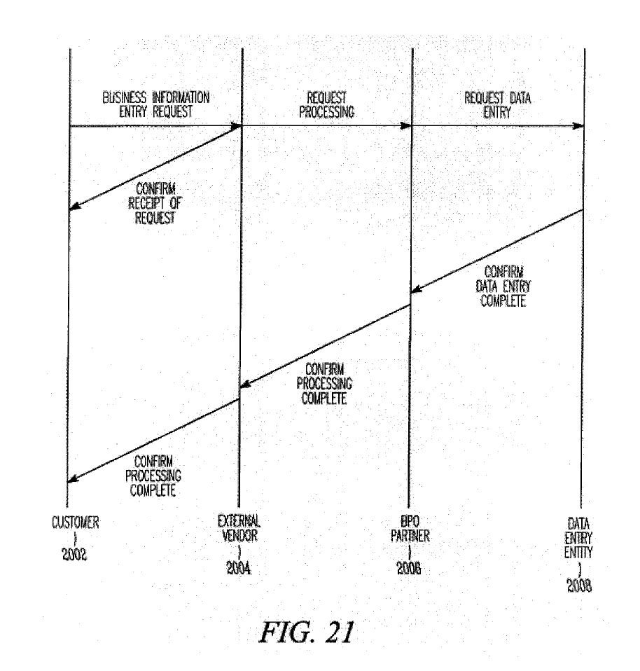

FIG. 21 is a diagram of a communication sequence for the business process shown in FIG. 20. FIG. 21 comprises four vertical lines representing the four business entities shown in FIG. 20 (customer 2002, external vendor 2004, BPO partner 2006, and data entry entity 2008). The arrows show the sequence of communications between the business entities. In the sequence of the communications shown in FIG. 20, there are three sets of communications, one request/multiple-response and two request/response pairs. The first set of communications is a request/multiple-response between customer 2002 and external vendor 2004. After external vendor 2004 receives request, external vendor 2004 sends back to customer 2002 confirmation of receipt of the request. The second set of communications is a request/response pair between external vendor 2004 and BPO partner 2006. The second request causes BPO partner 2006 to initiate a third set of communications between BPO partner 2006 and data entry entity 2008. The third set of communications is a request/response pair. After the third set of communications is complete, BPO partner 2006 communicates with external vendor 2004 and completes the second set of communications. External vendor 2004 then communicates with customer 2002 completing the first set of communications. Although the external vendor 2004 and the BPO partner 2006 are shown are illustrated as separate entities, in alternate embodiments, they may be the same entity.

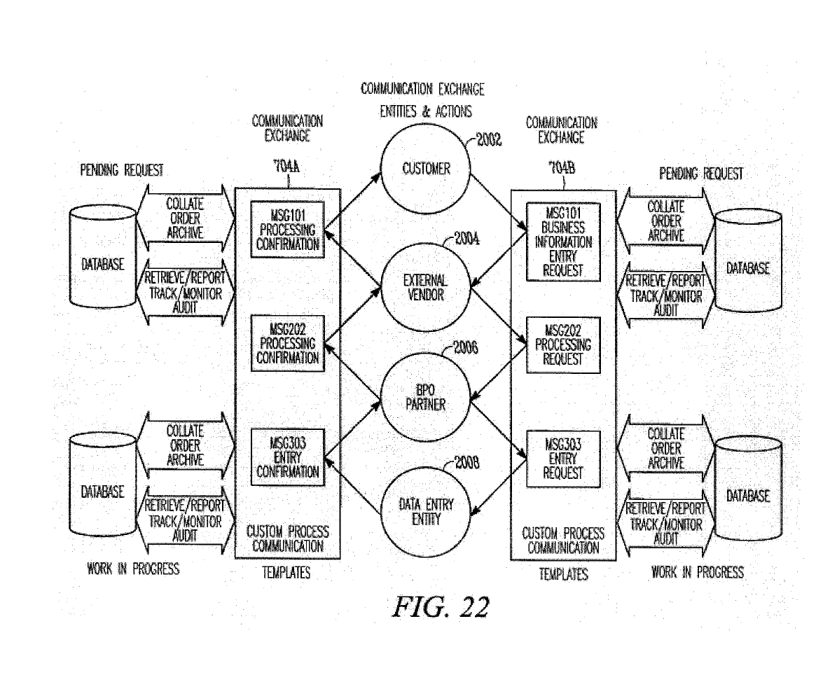

FIG. 22 is a diagram of an example operating environment for the communication sequence shown in FIG. 21 according to one embodiment of the invention. FIG. 22 comprises a first communication and information exchange (CIX) server 704a and a second CIX server 704b. The four business entities involved in the business process (customer 2002, external vendor 2004, BPO partner 2006, and data entry entity 2008) send and receive messages through the CIX servers 704a, 704b. The three sets of communications described by reference to FIG. 21 correspond to three business messages in the operating environment shown in FIG. 22. The business messages include both requests and responses. The business messages are identified by message IDs (e.g., MSG101, MSG202, MSG303). The message IDs are associated with process users that are part of the business process. For example, customer 2002 sends MSG101 with an information entry request to external vendor 2004. External vendor 2004 sends initial response back to customer 2002 to confirm receipt of the request. Once external vendor 2004 receives confirmation that the information entry is complete, external vendor 2004 sends a second response to customer 2002 to confirm completion of request. Likewise, MSG202 is sent with a request/response from external vendor 2004 to BPO partner 2006. Later BPO partner 2006 completes and returns the response in MSG202 to external vendor 2004. In addition, BPO partner sends MSG303 with a request/response to data entry entity 2008 and data entry entity 2008 completes and returns the response in MSG303 to BPO partner 2006.

The four entities in the business process group (customer 2002, external vendor 2004, BPO partner 2006, and data entry entity 2008) are communicating through the CIX servers 704a, 704b. The CIX servers 704a, 704b provide the ability at each point in the communication sequence to collate, order, archive, retrieve/report, track/monitor, and audit requests for work in progress according to example embodiments of the invention.

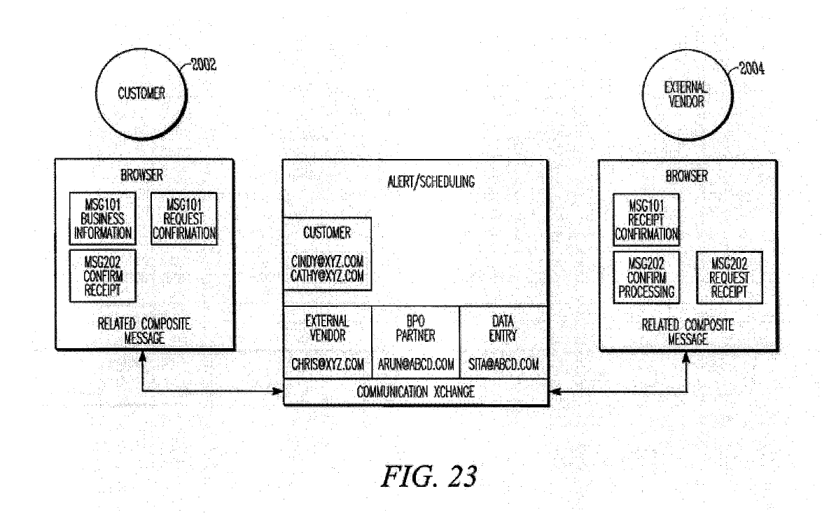

FIG. 23 is a more detailed diagram of the communication sequence for MSG101 shown in FIG. 22 according to one embodiment of the invention. As shown in FIG. 23, MSG101 is a request/response business message that is sent from customer 2002 to external vendor 2004. The business message has both static and dynamic content. The static content is the business information processing request portion of the message. The dynamic content is the request receipt confirmation and the completed information processing confirmation portions of the message. External vendor 2004 sends back individually just each response part of the message (i.e., the MSG101 receipt confirmation and the request completed confirmation). All external vendor 2004 has to do is read the request message(s), fill in the information requested from customer 2002 when it is available, and send back the communication to customer 2002. The CIX server provides alerts and scheduling for the communication. For example, if external vendor 2004 fails to respond to the request within a predetermined period of time, an alert may be generated to remind the process users for external vendor 2004 to complete the request.

Business Process Reporting Example. FIGS. 24, 25, 26 and 27 are diagrams illustrating a business reporting example according to an embodiment. FIG. 24 is a diagram of an example business process for business reporting. FIG. 24 illustrates four business entities: an experiment 2402, an information system 2004, a reporting system 2406, and audiences 2408A, 2408B. The process begins when experiment 2402 posts results to information system 2404. Then, information system 2404 responds to experiment 2402 with a confirmation that the results were received and reports will be made and distributed. Next, information processing system 2404 makes a request to reporting system 2406 for distribution of the reports. Reporting system 2406 sends confirmation of request back to information system 2404 and then reporting system 2406 sends reports to external audience 2408A and internal audience 2408B. Once external audience 2408A and internal audience 2408B have received the reports, each audience responds to reporting system 2406 confirming receipt of the reports. Reporting system 2406 receives the receipt conformation from each audience and reporting system 2406 then submits a response to information processing system 2404 confirming that processing is complete. Information processing system 2404 then responds to experiment 2402 confirming that processing of the results is complete. In previous systems, the process users in the four business entities shown in FIG. 24 were required to use a variety of systems and information sources to fulfill request such as the requests in this example. In addition to the inefficiency of using disparate systems, these ad hoc requests and responses did not allow for tracking and monitoring business processes.

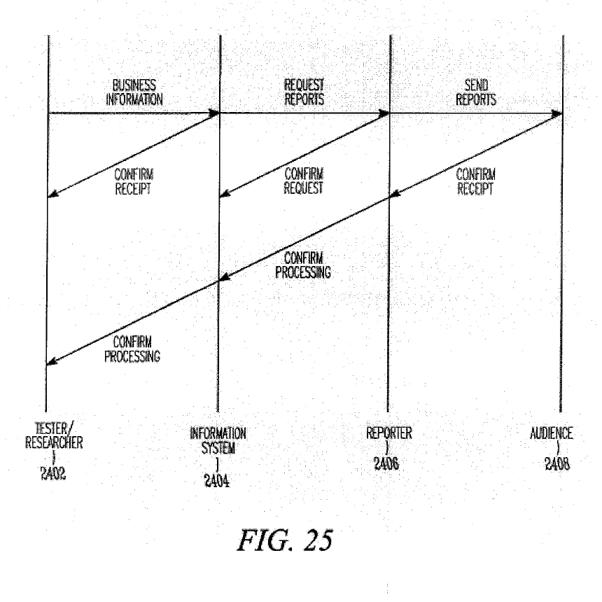

FIG. 25 is a diagram of a communication sequence for the business process shown in FIG. 24. FIG. 25 comprises four vertical lines representing the four business entities shown in FIG. 25 (experiment 2402, information processing system 2404, reporting system 2406, and audiences 2408A, 2408B). The arrows show the sequence of communications between the business entities. In the sequence of the communications shown in FIG. 25, there are four sets of communications, two request/multiple-responses and two request/response pairs. The first set of communications is a request/multiple-response between experiment 2402 and information processing system 2404. After information processing system 2404 receives request, information processing system 2404 sends back to experiment 2402 confirmation of receipt of the request. The second set of communications is a request/multiple-response between information processing system 2404 and reporting system 2406. After reporting system 2406 receives request, reporting system 2406 sends back to information processing system 2404 confirmation of receipt of the request. The request of information processing system 2404 causes reporting system 2406 to initiate the third and fourth sets of communications between reporting system 2406 and audiences 2408A, 2408B. The third and fourth sets of communications are request/response pairs. After the third and fourth sets of communications are complete, reporting system 2406 communicates with information processing system 2404 and completes the second set of communications. Information processing system 2404 then communicates with experiment 2402 completing the first set of communications.

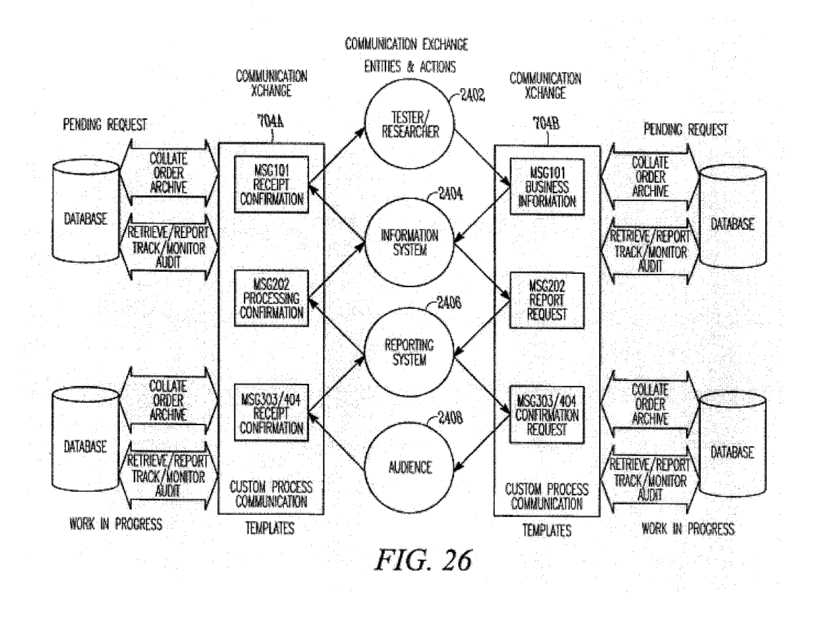

FIG. 26 is a diagram of an example operating environment for the communication sequence shown in FIG. 25 according to one embodiment of the invention. FIG. 26 comprises a first communication and information exchange (CIX) server 704a and a second CIX server 704b. The four business entities involved in the business process (experiment 2402, information processing system 2404, reporting system 2406, and audiences 2408A, 2408B) send and receive messages through the CIX servers 704a, 704b. The four sets of communications describes by reference to FIG. 25 correspond to four business messages in the operating environment shown in FIG. 25. The business messages include both requests and responses. The business messages are identified by message IDs (e.g., MSG101, MSG202, MSG303, MSG404). The message IDs are associated with the process users that are part of the business process. For example, experiment 2402 sends MSG101 posting results to information processing system 2404. Information processing system 2404 sends initial response back to experiment 2402 to confirm receipt of the results. Once information processing system 2404 receives confirmation that the result processing is finished, information processing system 2404 sends a second response to experiment 2402 to confirm completion of processing. Likewise, MSG 202 is sent with a request/response from information processing system 2404 to reporting system 2406 and reporting system sends back a receipt of request. Later reporting system 2406 completes a second response and returns the second response in MSG202 to information processing system 2404. In addition, reporting system 2406 sends MSG303 and MSG404 each with a request/response to external audience 2408A and internal audience 2408B. Each audience 2408A, 2408B completes and returns the response in respective MSG303 or MSG404 to reporting system 2406.

The four entities in the business process group (experiment 2402, information processing system 2404, reporting system 2406, and audiences 2408A, 2408B) are communicating through the CIX servers 704a, 704b. The CIX servers 704a, 704b provide the ability at each point in the communication sequence to collate, order, archive, retrieve/report, track/monitor, and audit requests for work in progress according to example embodiments of the invention.

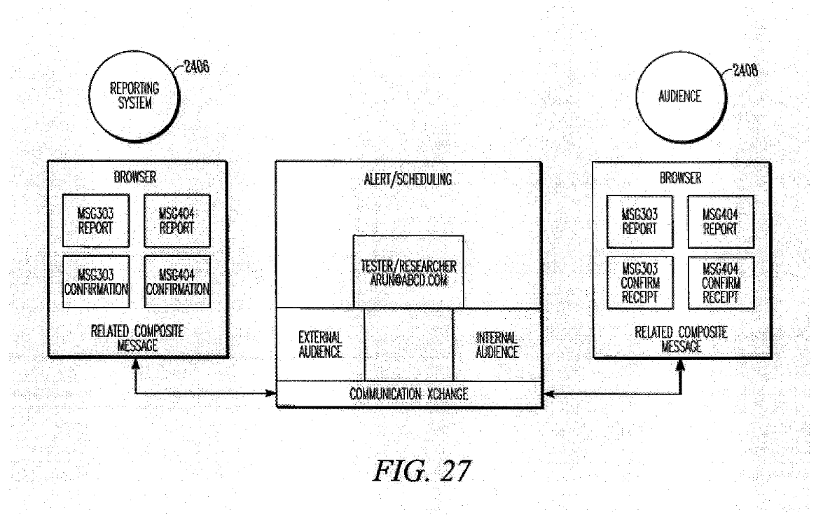

FIG. 27 is a more detailed diagram of the communication sequence for MSG303 and MSG404. As shown in FIG. 27, MSG303 and MSG404 are request/response business messages that are sent from reporting system 2406 to audiences 2408A, 2408B. Each business message has both static and dynamic content. The static content is the report portion of the messages. The dynamic content is the report receipt confirmation portion of the messages. Each audience 2408A, 2408B sends back just the response part of the message (i.e. the MSG303 confirm receipt and the MSG404 confirm receipt). All each audience 2408A, 2408B has to do is receive the report and send back the receipt communication to reporting system 2406. The CIX server provides alerts and scheduling for the communication. For example, if reporting system 2406 fails to respond to the request within a predetermined period of time, an alert may be generated to remind the process users for reporting system 2406 to complete the request.

The business process shown in FIGS. 16-27 are automated using communication-based business process messaging. As illustrated above, example embodiments of the invention organize a business process based on its communication components. Embodiments of the invention integrate information relevant to a business process with the communication components of the business process. In this way, the communication components (i.e., the messages) drive the business process. Information relevant to a business process is integrated with the communication components and provides a number of useful results, including:
information containers are designed for a business process (e.g., document, report/template, application containers, etc.), with rules such as validation, mapping, and formulas,
other information resources are described for a business process (e.g., collaboration, fax, etc.),
messages are designed to include static requests, static/dynamic responses, and hooks to associate multiple information resources and process users,
process groups are defined to include only the process users relevant to a particular inter or intra business process,
process workflows are designed comprising of events that will trigger communication requests, will send alerts, will monitor and track state changes, etc., and
process message queues are defined (e.g., request queues, work in progress queues and fulfilled queues).
composite message data structures provide a common interface between different modes of communication within a business process
software tools manage a communication workflow for a business process
a user interface displays a synopsis of one or more business processes
a user interface provides an alert, notification, reporting, and tracking mechanism for all business process communications

Embodiments of the invention have broad applicability beyond business process automation, business process outsourcing, business process reporting (e.g., health data etc.) such as any intra-office processes, any inter-office processes, business process auditing, and to name a few.

In some embodiments, a communication-based business process messaging system as described herein may be integrated with other systems such as an electronic mail system, a business process management system, a help desk system, and an enterprise application. For example, the Communication and Information Exchange server may be implemented on top of an email system, a Business Process Execution Language (BPEL)/XML Process Description Language (XPDL) Business Process Management (BPM) system, or a helpdesk/Customer Relationship Management (CRM)/Enterprise Resource Planning (ERP) system.

In other embodiments, a communication-based business process messaging system as described herein may be used to deploy various applications including, but not limited to, a virtual courier application, a virtual postbox application, a data entry application, a reporting application, a business process messaging application, a business process outsourcing application, a business process auditing application, a business process reporting application, a business-to-business application, a business-to-consumer application, a business-to-government application, a business-to-business application, or a government-to-government application.

### Assembly Line

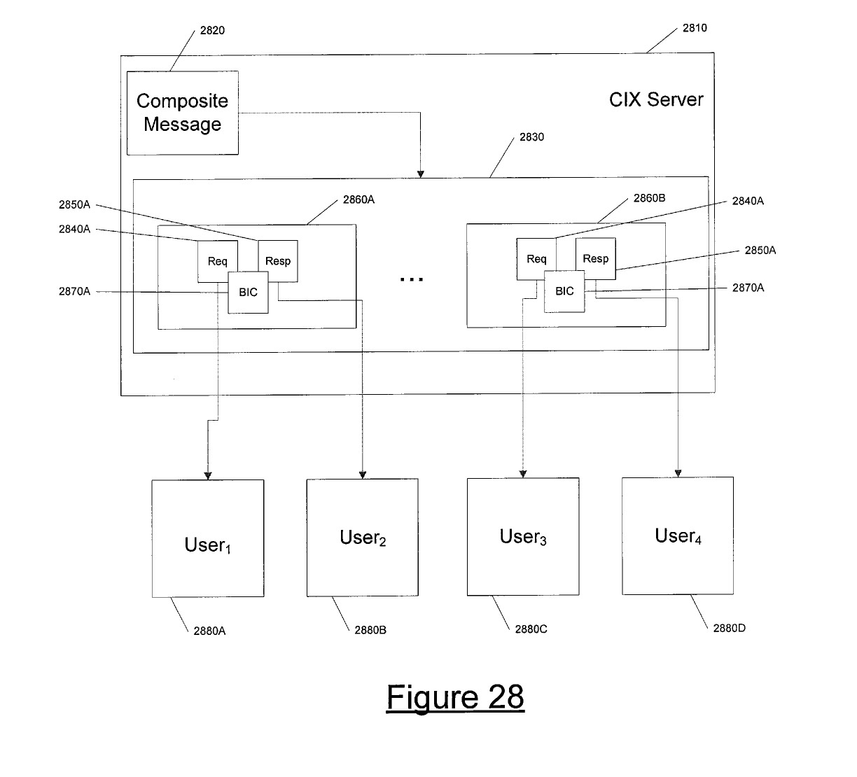

FIG. 28 illustrates an implementation of a Communication and Information Exchange (CIX) according to various embodiments. FIG. 28 comprises a CIX server 2810, a composite message 2820, an information assembly line 2830, a number of information assembly line paths 2860A, 2860B including requests 2840A, 2840B and responses 2850A, 2850B, Business Information Containers (BIC) 2870A, 2870B, and one or more users 2880A-2880D.

The CIX server 2810 may put into motion an information assembly line 2830 which may proceed to collect information according to a specified process. The CIX server 2810 begins to orchestrate and manage the information assembly line 2830 based on the information specified in the composite message. The composite message 2820 may include a comprehensive business process communication and information exchange definition or other predefined set or subset of instructions for assembly line orchestration and information processing and management. The composite message 2820 may be created from a preexisting template or may alternatively be defined as a new object defining the necessary information exchange. An information exchange may include a number of functions including collaboration, co-operation, sharing, submission, and other information and communication interactions.

Once initiated in the CIX server 2810, the composite message 2820 sets in motion an information assembly line 2830 which works to obtain relevant business information. The information assembly line 2830 may be an information assembly mechanism that works to procure information through the data within requests 2840A, 2840B and responses 2850A, 2850B which is stored and correlated in a BIC 2870A, 2870B. In order to obtain information, a number of requests 2840A, 2840B and responses 2850A, 2850B may be used. To gather information and implement the requests 2840A, 2840B and responses 2850A, 2850B, the CIX sequence 2830 initiates one or more information assembly line paths 2860A, 2860B. The information assembly line paths 2860A, 2860B provide the structure for receiving and delivering requests 2840A, 2840B and responses 2850A, 2850B. Once information is received along a information assembly line path 2860A, 2860B through requests 2840A, 2840B and responses 2850A, 2850B, the information is stored in an associated BIC 2870A, 2870B. The BIC 2870A, 2870B acts as a shell for storing gathered information. A BIC 2870A, 2870B may be more complex than just a simple shell for information storage, it may additionally include any number of inner shells to compartmentalize the information that is being gathered and stored. Once information is stored in the BIC 2870A, 2870B, it may be collected and correlated for later use and consumption.

The composite message 2820 defines the process for collecting and correlating information as well as the particular actors (which may include people, groups, sub-groups, systems or other potential actors) that will be involved in the process based on an established discipline. Various users 2880A-2880D may be assigned different roles within the system and along particular information assembly line paths 2860A, 2860B. One particular user 2880B may be involved on one information assembly line path 2860A, and his or her role may involve responding to a request from another user 2880A. Users 2880A-2880D are not limited to just one information assembly line path 2860A, 2860B, or even just one CIX sequence 2830. A user 2880A-2880D may be involved on any number of information assembly line paths 2860A, 2860B or business processes defined by varying composite messages 2820. A user 2880A-2880D need not be a particular person but may also be represented by a system or a group.

An example implementation according to an embodiment may involve a composite message 2820 regarding a reference check process. Once the composite message is received by the CIX server 2810, an information assembly line 2830 may begin. Information assembly line path 2860A may represent an academic reference check, and information assembly line 2860B may represent a personal reference check. The information assembly line path 2860A representing the academic reference check may involve an HR employee as a user 2880A and a professor as another user 2880B. A request 2840A may be initiated by the HR employee user 2880A and a response 2850A elicited from the professor user 2880B. As information is gathered, it may be stored in the BIC 2870A associated with the request 2840A and response 2850A. A similar circumstance may apply for the personal reference check information assembly line path 2860B.

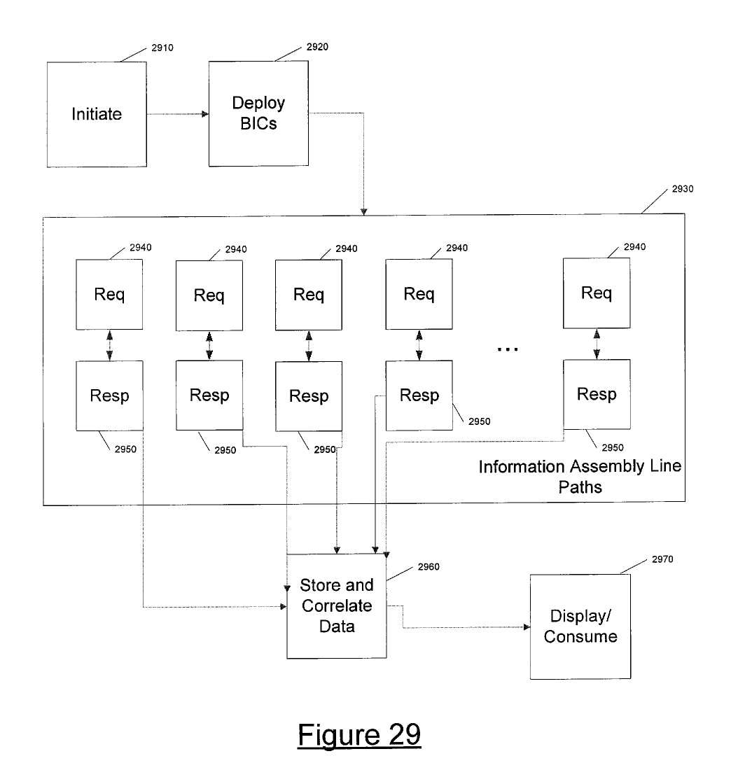

FIG. 29 illustrates an example process for collecting business information according to various embodiments. FIG. 29 comprises an initiation stage (block 2910), a BIC deployment stage (block 2920), a group of information assembly line paths 2930 including a number of requests 2940 and responses 2950, a data storage and correlation stage (block 2960) and a display/consume stage (block 2970).

To begin a business process, an initiation condition may be carried out (block 2910). This initiation condition may be any action that would invoke a new business process. For example, the submission of a resume may be treated as an initiation condition invoking a business process including reference and background checks and an exchange of information. The presence of the initiation condition invokes the deployment of a BIC (block 2920) and the commencement of one or more sequences in information assembly line paths 2930. The information assembly line paths 2930 provide a way to effectively communicate, exchange, and collect business information. Although they are referred to as assembly “lines”, the functions in the assembly process may be operated sequentially or in parallel. The information assembly line paths 2930 propagate a number of requests 2940. The type and sequence of the requests is governed by a workflow paradigm which may be defined by certain rules or preferences at the initiation of the business process. The workflow paradigm may establish the type of requests 2940 and responses 2950 to be directed to various users along the information assembly line paths 2930. These requests 2940 are directed toward specific users, groups of users or systems. The requests 2940 may be delivered on a user-to-user, system-to-user or a system-to-system basis. The users may act on the requests 2940 to provide responses 2950. Responses 2950 provide business information and fulfill a particular state in one or more information assembly line paths 2930.

As requests 2940 and responses 2950 are being delivered to users and systems, a number of these communications may reach a particular user or system at similar times. Queues of requests and responses for users or systems may be established to manage the incoming or outgoing flow of requests 2940 and responses 2950. One request queue may be handled by multiple users/systems (based on availability, choice, severity and priority) or multiple request queues may be mapped to multiple users/systems (including 1−1 mapping between request/responder or other schemes such as n−1 mapping as well). The message mapping schemes are described in more detail by reference to FIGS. 13A, 13B, and 13C. Additionally, queues may be set up for groups of users grouped by their similar roles (for example consumer, provider, checker, and so on).

A response 2950 to a request 2940 at one point in the information assembly line 2930 may provide information to form a new request 2940 further down the information assembly line paths 2930. If a request 2940 asks a user for a specific piece of information, and the user submits a response 2950, that response may be verified through the use of a subsequent request 2940 to a second user capable of verifying such information. An example of such a situation might be a request for academic information from a job applicant. The applicant responds with an answer that his grade point average (GPA) in college was a 3.7. This number may then be verified through a request sent to the registrar at the applicant's college. The registrar's response may verify the job applicant's response. The order of these requests and responses in not always important because the request could be simply sent to the registrar of the college and responded to first, then the job applicant's response could be verified as soon as his response is received.

As the responses 2950 to the requests 2940 are completed, they are retrieved and stored and correlated in the BIC (block 2960). Storing all of the information in BICs provides a single place to retrieve the information later, rather than having to access and attempt to correlate a number of documents. Once each stage along the sequence has reached fulfillment, the information assembly line paths 2930 have reached their end. Fulfillment of a state along the sequence does not necessarily occur through a fully responsive response to a request. A state along a sequence of an information assembly line path 2930 may be fulfilled in a number of other ways including timeout, undeliverable request, declined request and other conditions. These states may be optionally accompanied by appropriate alerts or notifications. Once the information assembly line paths 2930 have reached their end, the data stored in the BIC may be displayed, reported out, and consumed in any number of ways (block 2970). Alternatively, the data stored in the BIC may be displayed or reported while the information assembly line paths 2930 are still in the process of gathering information.

### Search and Reporting

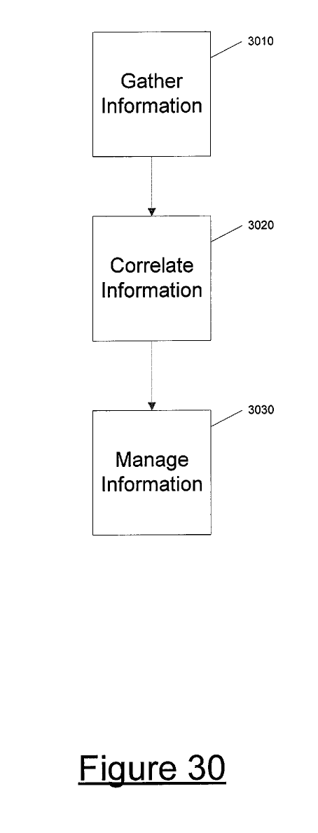

FIG. 30 illustrates a method for working with business information according to various embodiments. FIG. 30 comprises gathering information (block 3010), correlating information (block 3020), and managing the information (block 3030).

The processes described above include procedures for gathering information (block 3010). These procedures may be carried out in a number of ways according to the information needs of a particular business process. Once gathered, the information may be correlated (block 3020). The correlation may be as simple as storing the information in a common place for future reference, or may be more complex by creating databases with related and cross-linked tables and fields for example. This correlation allows for efficient organization of the information in a single place for easy access through a search or filter. Once correlated, or even during correlation or gathering, information may be managed by a user or system (block 3030). The management process may similarly be as simple as displaying lines of text or more complex by graphically displaying relationships and functions of the information. Management of the information may also include transforming data, transacting the data or consuming it as necessary to suit the needs of the users or systems accessing the information. At times simple display options can be useful, and at other times more complex representations and functions are useful and necessary. Management (block 3030) may also include accessing the data through a search or filtering process. Data may be organized and correlated in such a way as to make the search and filtering process simple. Methods for reaching this end are described below.

As part of organizing and displaying information, a threading module may also be used to maintain and manage requests, responses, notifications and other communications. The threading module may correlate and display related communications in a number of ways. The implementation of the threading module may weave the requests and responses (which may be 1−1, n−1, 1−n, n 1−1 communication types) into a co-related threaded chain. The organization of a particular displayed thread may be determined by a user's role or preferences.

According to various embodiments, the ability to search, filter and create customized displays and reports is also available. In order to effectively search and manipulate the information that is gathered, field based formats for data collection and storage may be used. Field based formats assign particular portions of requests and responses to particular fields. One example field based format is the Extensible Markup Language (XML). This language allows for field based organization of information for a number of purposes, it allows for implementation of rules, conditions and criteria such as logic, formulae, flags, type checking, validations, internationalization etc., which can be used dynamically for various purposes of information management, such as for references, querying attributes, etc. XML is not the only field based format that may be used, a number of other systems may be used effectively as well.

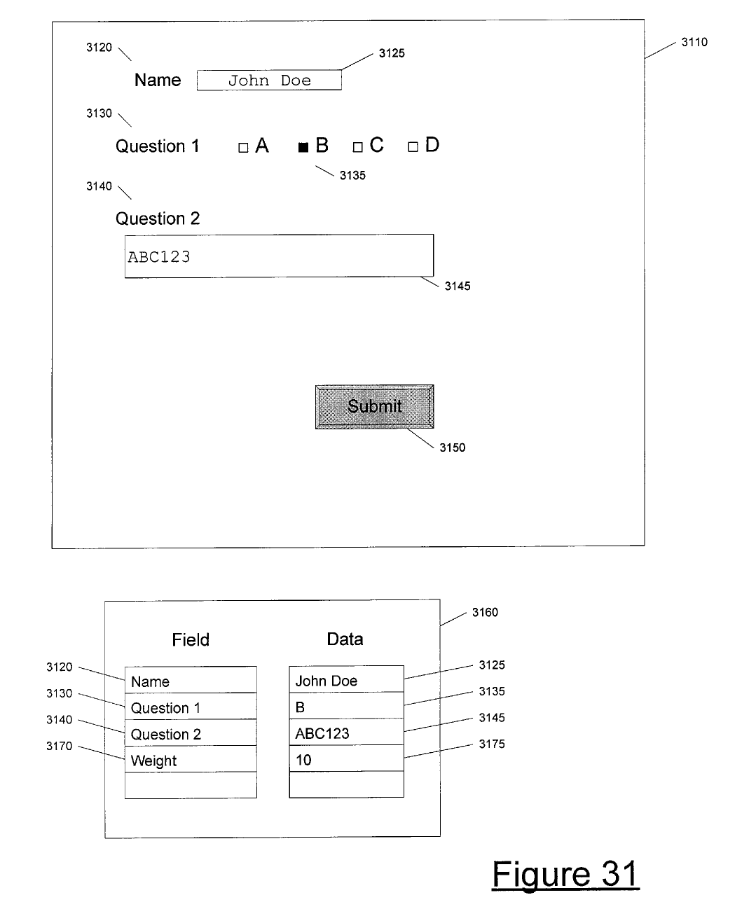

FIG. 31 illustrates an example request form 3110 and corresponding response data 3160 according to an embodiment. The request form comprises a name field 3120, name data 3125, a question 1 field 3130, question 1 data 3135, a question 2 field 3140, question 2 data 3145, and a submit button 3150. The response data comprises the name field 3120, name data 3125, a question 1 field 3130, question 1 data 3135, a question 2 field 3140, question 2 data 3145, a weight field 3170 and weight data 3175.

An example request 3110 may be sent out to a user in order to invoke a response 3160 and gather various information. The request 3110 includes a name field 3120 and an associated area for the user to input his or her name data 3125. Additionally, a question 1 field 3130 may accompanied by check boxes to represent question 1 data 3135, and a question 2 field 3140 may be accompanied by a text box for question 2 data 3145. Once the request 3110 is completed, the user may submit it by clicking the submit button 3150. Once submitted, the data is retrieved as a response and is organized on a field-by-field basis. Rather than providing the response data 3160 as a single block text return of the data, the data is broken down and separated by its associated field. For instance, the name data 3125 “John Doe” is associated with the name field 3120. Additionally, in the response extra fields and associated data may be apparent. In this case, the weight field 3170 and weight data 3175 are included in the response. This information may have been applied to the request before it was sent to the user. In this case, the users responses have been previously assigned a weight value which might be used when comparing the response data with other users response data.

Extra or hidden fields similar to the weight field 3170 and weight data 3175 may be provided in the requests sent to the users. These fields may serve a number of purposes including weighting, indexing, or other functions. Other similar non-form based data may include audit data. Audit data may consist of time, efficiency, compliance, and other statistical data that may be attached to a request or response for auditing or reporting functions.

All business information created or gathered may be stored as metadata, using a field based format. This approach may allow for greater organization and easier searching and reporting on the information.

By employing a metadata approach to storing and collecting information parsed into fields, that information may be more easily and efficiently searched, filtered and displayed. When separated into various fields, the information is essentially broken into its smallest form. In this way, it may be arranged and rearranged in any number of ways based on the needs of the viewer. Different users may only need to view particular portions of all of the information gathered. Rather than having to look over unnecessary information, a search or filtering module may find and display the specific fields and associated data needed for a particular user. Rules or preferences may govern reporting of gathered information. A user may define these rules or preferences to generate a report. This report may be for the user's benefit or for the benefit of other users or other 3^{rd} parties.

The search functionality may be implemented at any stage within the system. Since all of the information stored is stored as metadata in a field based format, searching is simple. A toolbar may be available for ease of searching at any place within the system.

### Communication System

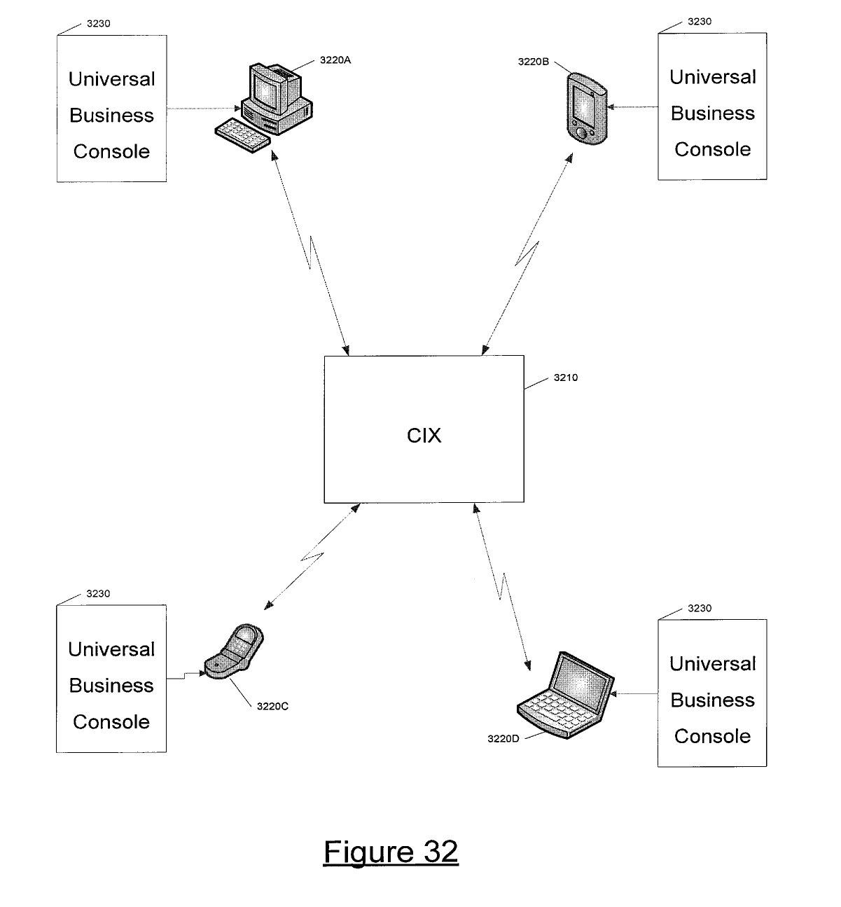

FIG. 32 illustrates a communication system according to various embodiments. FIG. 3 comprises a CIX 3210, a number of communication devices 3220A-3220D including a desktop computer 3220A, a Portable Digital Assistant (PDA) 3220B, a mobile phone 3220C and a laptop computer 3220D, as well as a universal business console 3230 on each communication device 3220A-3220D.

Communication is what drives the inventive subject matter. The ability to manage a business process by managing communication is disclosed. Managing the interfaces and channels of communication is useful in controlling and efficiently running a communication system. At the center of the system is a CIX 3210. The CIX 3210 provides one or more processes for communicating with the various users of the system. Because actual communication devices 3220A-3220D will vary from business to business and from person to person, the system has the ability to effectively communicate with a number of communication devices 3220A-3220D. One user may be communicating from a workstation via a desktop computer 3220A at the same time another is waiting at an airport and is only available through his wireless-enabled PDA 3220B. The CIX 3210 may have the ability to handle incoming and outgoing messages formatted for the specific type of communication device 3220A-3220D and protocol being used by a particular user. Residing on each communication device 3220A-3220D is a universal business console 3230. The universal business console 3230 may provide a platform independent console that may be used to communicate from any communication device 3220A-3220D. The universal business console 3230 may include common user experience modules to help provide a similar experience in use between varying communication devices 3220A-3220D. According to another embodiment, the universal business console 3230 may appear in a full version on more robust devices like the desktop computer 3220A or the laptop computer 3220D, but may be scaled back to match the limited functionality of smaller devices like a mobile phone 3220C.

The communication system allows users to interact and communicate regardless of what type of communication device 3220A-3220D they may have available. This effectively allows for a larger window of real-time communication capabilities. Whenever a user has a communication device 3220A-3220D available with the universal business console 3230 running, that user may be considered “live” on the system. By being “live” on the system, other users can see that particular user is available to receive a communication in real-time. Business information may be exchanged and communication flow may be kept up regardless of whether a user is on his laptop computer 3220D or simply on his mobile phone 3220C. Of course, the message format from one communication device 3220A-3220D to another may vary greatly. The communication system may manipulate messages in order to conform with a particular communication device 3220A-3220D or user preferences.

The communication system may also allow for users to set various preferences which may be determined by the type of communication device 3220A-3220D that they are using. These preferences may govern the type or format of message that is to be delivered to the particular user when a new message comes through. The preferences may also govern the protocol used to transmit the message. This allows messages to enter the communication system in any format and be delivered in any format based on a user's preferences. When using a desktop computer 3220A, for example, a preferred message format may be a fully marked-up email message. On the other hand, when using a mobile phone 3220C, the preferred format and protocol may be using an SMS message.

The CIX 3210 may contain a number of modules to work with the preferences set by various users. One of such modules may include a receive module which is operable to receive incoming messages in various formats. Another module may be a transmit module which is operable to transmit messages to users in various formats. The transmitted format of a message may be governed by the particular user's preference data. As an example, a message may enter the system in a first format, perhaps SMS, and may then be translated into a second format, perhaps plain-text email, before it is sent out to the final recipient. The management of the incoming and outgoing messages may be performed by a communication manager and or a translating module within the CIX 3210. Any such module with access to the user preferences may be used to manage the communications in this way. Additionally, this communication manager need not be located cantrally within the CIX 3210, but may be optionally run separately on each communication device 3220A-3220D.

By simplifying the process for communicating the communication system allows for a more seamless collaboration, and communication convergence within business processes. Since all business information is transmitted and changed hands only through varying types of communication, a more efficient and organized communication system within the business environment may increase productivity and simplify the workflow. The communication system modules may be designed, developed and deployed using off the shelf openly available components and/or may be engineered from scratch in-house based on future trends or emerging standards.

### Hardware and Operating Environment

This section provides an overview of an example hardware and the operating environments in conjunction with which embodiments of the inventive subject matter can be implemented. In some embodiments, the software is implemented as an application program. In other embodiments, the software is implemented as a hosted service. In still other embodiments, the software is implemented over an intranet and/or an internet using a Web browser user interface.

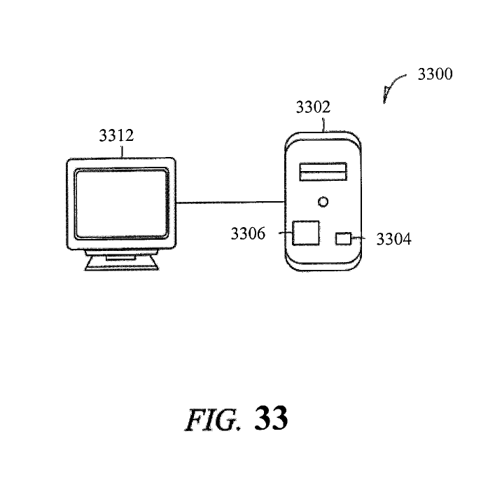

FIG. 33 is a diagram of an example hardware environment for a computerized system according to an example embodiment. The system 3300 includes a computer 3302 having a processor 3304 and a computer readable medium 3306 such as a memory or a mechanism for storing data. The computer readable medium 3306 has stored therein, software for carrying out tasks in accordance with various aspects of the present inventive subject matter. In this embodiment, the software performs methods of automating and integrating business processes using communications based business process messaging.

The computer 3302 may be any suitable hardware and/or software, and includes many types of devices. For example, the computer 3302 includes personal computers, portable computers, laptop or notebook computers, Personal Digital Assistants (PDAs), pocket computers, and other devices. The other devices include any device that uses firmware associated with the device. The software of computer 3302 includes not only firmware, but also operating systems such as a Macintosh operating system, Microsoft Windows, PalmOS, Linux, UNIX, IBM OS/390, and other such operating systems. The hardware and software varies based on factors associated with specific applications.

Furthermore, although the computer 3302 is drawn to contain the memory 3306, the memory 3306 or other storage device can be distributed across other computers 3302 or computing devices operatively coupled to the computer 3302 such as by a network or other wired or wireless communication link such as a network.

The display 3312 is one part of the computer 3302 that communicates output from the computer 3302. In one embodiment, the display 3312 is an integrated component of the computer 3302, such as a flat panel display on an exterior housing of the computer 3302 in the form of a handheld computing device, a PDA, a telephone, or a notebook computer. In another embodiment, the display 3312 is a separate, stand-alone device.

The software in various embodiments includes machine executable instructions for carrying out various tasks of the present inventive subject matter. In some embodiments, the software 2908 includes instructions written in a computer language such as C or C++, Java, C# and scripts such as PERL, Shell and batch files.

In some embodiments, the software is operable on the processor 2904 for causing the computer 2902 to improve business process efficiency.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A computerized system comprising:
at least one shell to maintain information;
at least one request related to the information;
at least one response related to the at least one request;
a workflow paradigm to govern the requests and the responses.

2. The computerized system of claim 1, further comprising an information assembly mechanism defined by the workflow paradigm operable to deliver the requests and the responses to collect information in at least one shell.

3. The computerized system of claim 1, further comprising one or more inner shells within the shell to maintain the information.

4. The computerized system of claim 1 further comprising one or more rules within the workflow paradigm.

5. The computerized system of claim 1, further comprising a queue operable to hold at least one request.

6. The computerized system of claim 5, wherein the queue holds a request until a response is given with respect to the request.

7. The computerized system of claim 1, further comprising at least one interface to display the information.

8. The computerized system of claim 1, further comprising a threading module to organize related requests and responses.

9. The computerized system of claim 1, wherein the requests and the responses are provided in a field based format.

10. The computerized system of claim 9, further comprising a search module operable to search and filter the incoming communications and the outgoing communications using on one or more fields of the field based format.

11. The computerized system of claim 1, further comprising a reporting module to provide a report based on the information in one or more formats.

12. A communication system comprising:
preference data related to at least one user;
a receive module to receive a communication for a first user in a first format; and
a transmit module to communicate the communication to the first user in a second format defined by the preference data.

13. The communication system of claim 12 further comprising a queue to hold one or more received communications.

14. The communications system of claim 12, wherein the communication is one of a request or a response.

15. The communication system of claim 12, wherein the message is defined by one or more discrete information fields.

16. A method comprising:
storing one or more preferences;
receiving a message in a first format;
checking the message for conformance with rules;
translating the message into a second format based on the preferences; and
communicating the message to a user in the second format.

17. The method of claim 16, wherein the message is defined by one or more discrete information fields.

18. The method of claim 16, wherein translating the message into a second format includes adjusting one or more of the discrete information fields.

19. The method of claim 16, further comprising receiving a response to the message.

20. The method of claim 19, further comprising correlating the message and the response.

21. The method of claim 20, further comprising displaying the message and the response to convey the correlation.

22. A communication system comprising:
a plurality communications modules operable to receive incoming communications and transmit outgoing communications;
a communications manager operable to manage and format the incoming communications and the outgoing communications; and
a platform independent user interface operable to present the user with the incoming communications and to allow the user to initiate outgoing communications.

23. The communication system of claim 22, further comprising a threading module to correlate the incoming communications and the outgoing communications.

24. The communication system of claim 22, wherein the incoming communications and the outgoing communications are provided in a field based format.

25. The communication system of claim 24, further comprising a search module operable to search and filter the incoming communications and the outgoing communications using on one or more fields of the field based format.

26. An article including a machine-accessible medium having associated information, wherein the information results in a machine performing a method comprising:
receiving incoming communications having business information data;
managing and formatting the incoming communications;
presenting the user with the incoming communications;
allowing the user to initiate outgoing communications having additional business information data using one or more interfaces;
managing and formatting the outgoing communications; and
transmitting the outgoing communications.

27. The article of claim 26 further comprising displaying the incoming communications and the outgoing communications to show an association between related incoming and outgoing communications.

28. The article of claim 26, wherein the incoming communications and the outgoing communications are provided in a field based format.

29. The article of claim 28, further comprising searching the incoming communications and the outgoing communications using on one or more fields of the field based format.

30. The article of claim 29, further comprising creating a report based on the searching of the incoming communications and the outgoing communications using one or more fields of the field based format.

31. The article of claim 30, further comprising maintaining the business information data and the additional business information data in a business information container.

32. The article of claim 31, further comprising searching the business information container, and the incoming communications and the outgoing communications to create a report.

33. The article of claim 26, wherein the one or more interfaces are platform independent.
